(19) United States
(12) Patent Application Publication
(10) Pub. No.: US 2013/0085847 A1
(43) Pub. Date: Apr. 4, 2013

(54) PERSISTENT GESTURELETS

(71) Applicants: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(72) Inventors: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(21) Appl. No.: 13/269,466

(22) Filed: Oct. 7, 2011

Related U.S. Application Data
(63) Continuation-in-part of application No. 13/251,046, filed on Sep. 30, 2011.

(51) Int. Cl. G06Q 30/02; G10L 21/00; G09G 5/00

(52) U.S. Cl. 705/14.49; 345/157; 704/275; 345/629; 704/E21.001

(57) ABSTRACT

Methods, systems, and techniques for automatically providing auxiliary content are provided. Example embodiments provide a Dynamic Gesturelet Generation System (DGGS), which enables one to dynamically define a gesturelet for navigating to or presenting other content, or for performing some behavior. In overview, the DGGS allows a portion of electronically presented content to be dynamically indicated by a gesture. The indicated portion can then be formed into a gesturelet and used by the DGGS to navigate to other content, perform a set of instructions, present auxiliary content, or for other purposes. Gesturelets may be stored persistently and associated with some auxiliary content, such as a set of behaviors, advertisements, competitions, supplemental material or images, or the like. Later, when an action in the system occurs such that the persistent representation is retrieved, the behavior associated with the persistent representation is performed and the associated auxiliary content presented.

### TECHNICAL FIELD

The present disclosure relates to methods, techniques, and systems for providing a gesture-based user interface to users and, in particular, to methods, techniques, and systems for providing persistent representations of gesturelets.

### BACKGROUND

As massive amounts of information continue to become progressively more available to users connected via a network, such as the Internet, a company intranet, or a proprietary network, it is becoming increasingly more difficult for a user to find particular information that is relevant, such as for a task, information discovery, or for some other purpose. Typically, a user invokes one or more search engines and provides them with keywords that are meant to cause the search engine to return results that are relevant because they contain the same or similar keywords to the ones submitted by the user. Often, the user iterates using this process until he or she believes that the results returned are sufficiently close to what is desired. The better the user understands or knows what he or she is looking for, often the more relevant the results. Thus, such tools can often be frustrating when employed for information discovery where the user may or may not know much about the topic at hand.

Different search engines and search technology have been developed to increase the precision and correctness of search results returned, including arming such tools with the ability to add useful additional search terms (e.g., synonyms), rephrase queries, and take into account document related information such as whether a user-specified keyword appears in a particular position in a document. In addition, search engines that utilize natural language processing capabilities have been developed.

In addition, it has becoming increasingly more difficult for a user to navigate the information and remember what information was visited, even if the user knows what he or she is looking for. Although bookmarks available in some client applications (such as a web browser) provide an easy way for a user to return to a known location (e.g., web page), they do not provide a dynamic memory that assists a user from going from one display or document to another, and then to another. Some applications provide “hyperlinks,” which are cross-references to other information, typically a document or a portion of a document. These hyperlink cross-references are typically selectable, and when selected by a user (such as by using an input device such as a mouse, pointer, pen device, etc.), result in the other information being displayed to the user. For example, a user running a web browser that communicates via the World Wide Web network may select a hyperlink displayed on a web page to navigate to another page encoded by the hyperlink. Hyperlinks are typically placed into a document by the document author or creator, and, in any case, are embedded into the electronic representation of the document. When the location of the other information changes, the hyperlink is “broken” until it is updated and/or replaced. In some systems, users can also create such links in a document, which are then stored as part of the document representation.

Even with advancements, searching and navigating the morass of information is oft times still a frustrating user experience.

### BRIEF DESCRIPTION OF THE DRAWINGS

FIG. 1A is a block diagram of example use of a gesturelet produced by an example Dynamic Gesturelet Generation System (DGGS) or process.

FIG. 1B is a block diagram of an example environment for using gesturelets produced by an example Dynamic Gesturelet Generation System (DGGS) or process.

FIG. 1C is a block diagram of example persistent representations of a gesturelet produced by an example Dynamic Gesturelet Generation System (DGGS) or process.

FIG. 1D is a block diagram of example use of a retrieved gesturelet produced an example Dynamic Gesturelet Generation System (DGGS) or process.

FIG. 1E is a block diagram of another example use of a retrieved gesturelet produced an example Dynamic Gesturelet Generation System (DGGS) or process.

FIG. 2A is an example block diagram of components of an example Dynamic Gesturelet Generation System.

FIG. 2B is an example block diagram of further components of the Input Module of an example Dynamic Gesturelet Generation System.

FIG. 2C is an example block diagram of further components of the Persistent Representation Generation Module of an example Dynamic Gesturelet Generation System.

FIG. 2D is an example block diagram of further components of the Auxiliary Content Determination Module of an example Dynamic Gesturelet Generation System.

FIG. 2E is an example block diagram of further components of the Gesturelet Association Module of an example Dynamic Gesturelet Generation System.

FIG. 2F is an example block diagram of further components of the Persistent Representation Retrieval Detection Module of an example Dynamic Gesturelet Generation System.

FIG. 2G is an example block diagram of further components of the Content to Present Determination Module of an example Dynamic Gesturelet Generation System.

FIG. 2H is an example block diagram of further components of the Target Content Determination Module of an example Dynamic Gesturelet Generation System.

FIG. 2I is an example block diagram of further components of the Presentation Module of an example Dynamic Gesturelet Generation System.

FIG. 3 is an example flow diagram of example logic for automatically providing portions of electronic content for association with auxiliary content.

FIG. 4 is an example flow diagram of example logic illustrating various example embodiments of block 304 of FIG. 3.

FIG. 5 is an example flow diagram of example logic illustrating various example embodiments of block 308 of FIG. 3.

FIG. 6 is an example flow diagram of example logic illustrating various example embodiments of block 308 of FIG. 3.

FIG. 7A is an example flow diagram of example logic illustrating various example embodiments of block 308 of FIG. 3.

FIG. 7B is an example flow diagram of example logic illustrating various example embodiments of block 308 of FIG. 3.

FIG. 8 is an example flow diagram of example logic illustrating various example embodiments of block 302 of FIG. 3.

FIG. 9 is an example flow diagram of example logic illustrating various example embodiments of block 302 of FIG. 3.

FIG. 10 is an example flow diagram of example logic illustrating various example embodiments of block 306 of FIG. 3.

FIG. 11A is an example flow diagram of example logic illustrating various example embodiments of block 310 of FIG. 3.

FIG. 11B is an example flow diagram of example logic illustrating various example embodiments of block 310 of FIG. 3.

FIG. 12A is an example flow diagram of example logic illustrating various example embodiments of block 310 of FIG. 3.

FIG. 12B is an example flow diagram of example logic illustrating various example embodiments of block 310 of FIG. 3.

FIG. 13 is an example flow diagram of example logic illustrating various example embodiments of block 302 of FIG. 3.

FIG. 14A is an example flow diagram of example logic illustrating various example embodiments of block 310 of FIG. 3.

FIG. 14B is an example flow diagram of example logic illustrating various example embodiments of block 310 of FIG. 3.

FIG. 14C is an example flow diagram of example logic illustrating various example embodiments of block 310 of FIG. 3.

FIG. 14D is an example flow diagram of example logic illustrating various example embodiments of block 310 of FIG. 3.

FIG. 15 is an example flow diagram of example logic illustrating various example embodiments of blocks 302 to 310 of FIG. 3.

FIG. 16 is an example block diagram of a computing system for practicing embodiments of a Dynamic Gesturelet Generation System.

### DETAILED DESCRIPTION

Embodiments described herein provide enhanced computer- and network-based methods, techniques, and systems for automatically providing auxiliary content. Example embodiments provide a Dynamic Gesturelet Generation System (DGGS), which enables a user using a gesture-based user interface to dynamically define any content that is able to be indicated by gesture as a “link” for navigating to or presenting other content, or for performing some behavior. In overview, the DGGS allows a portion of electronically presented content to be dynamically indicated by a gesture. The indicated portion can then be used by the DGGS to navigate to other content (without necessitating a link being embedded in the underlying content), perform a set of instructions, present auxiliary content, or for other purposes. This dynamic cross-reference to other content is termed a “gesturelet.”

Gesturelets may be stored using a persistent representation (e.g., a persistent state, storage, etc.) and associated with some auxiliary content, such as a set of behaviors, advertisements, competitions, supplemental material or images, or the like. Later, when an action in the system occurs such that the persistent representation is retrieved, typically as the result of some user action (like a particular type of gesture) or presentation of particular content (such as a web page, document, or the like that is indicated by the gesturelet), the behavior (e.g., instructions, images, text, etc.) associated with the persistent representation is performed and the associated auxiliary content presented.

For example, in some embodiments, a set (e.g., list, array, table, etc.) of gesturelets, created and persistently stored, may be associated with a user, an application, particular content such as a particular web page or document, an environment, a server service, etc. When a user (or service) initiates a gesture action that “matches” (e.g., “best matches”) one of the set of gesturelets, the corresponding behavior and/or content associated with the gesturelet may be performed and/or presented. In this scenario, the gesturelet corresponds to some portion of electronic content such, a particular phrase, word, sentence, etc., or to a type of gesture (corresponding to “any” portion of electronic content—like a wildcard) or the like. The persistent representation of the gesturelet embodies a set of instructions with possible parameters such as context (e.g., an indicated phrase, sentence, image, document title, web page url, etc.), gesture attributes (e.g., style, weight, color, direction, shape, etc.), and the like, that may be defined separately and/or even after the environment in which it is being invoked has been coded or defined.

Accordingly, gesturelets may be used to navigate to other content; to perform a (self-) described behavior, such as to spell check, present market options, present an advertisement associated with the gesturelet, present a list of competition options, related choices, etc.; to present supplemental or auxiliary content; and the like. Thus, they act as a kind of “omnipotent” link that can be defined at any time: e.g., ahead of use, added to a system later, or defined at any other time.

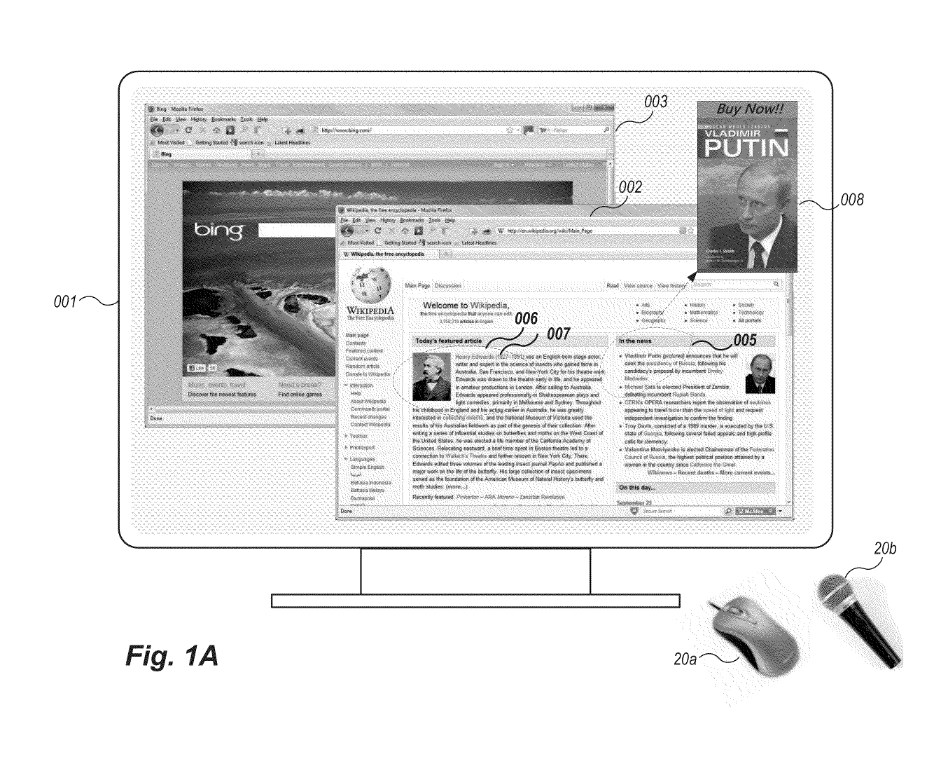

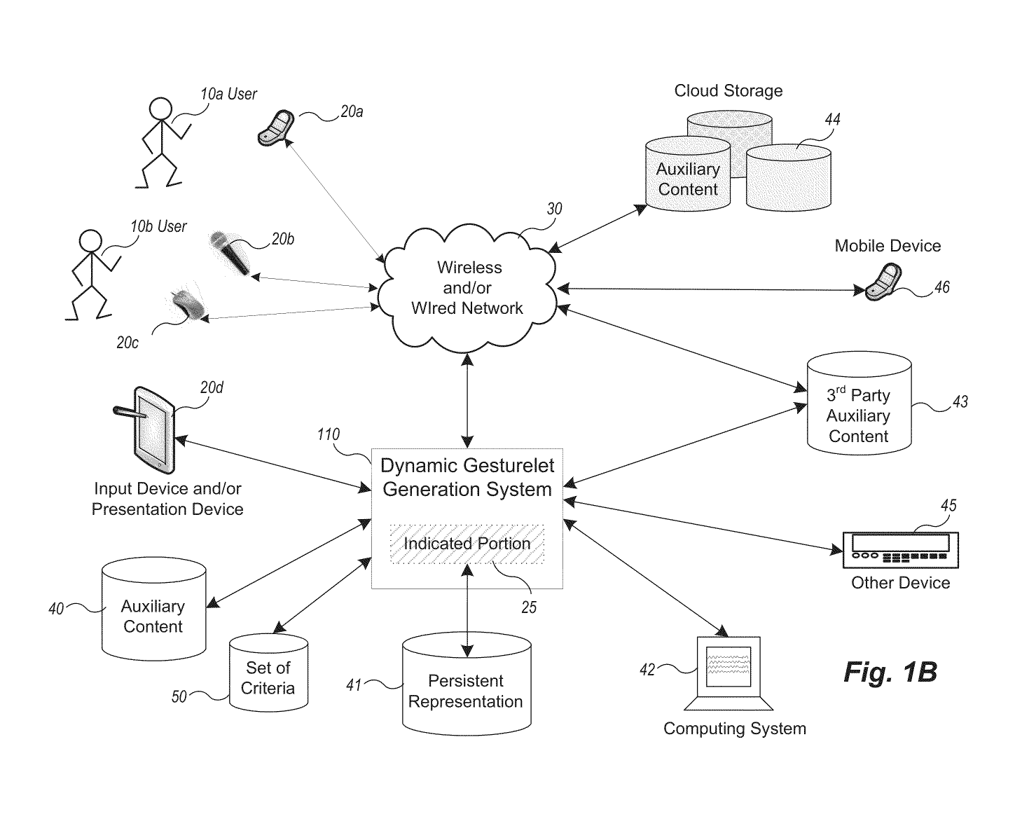

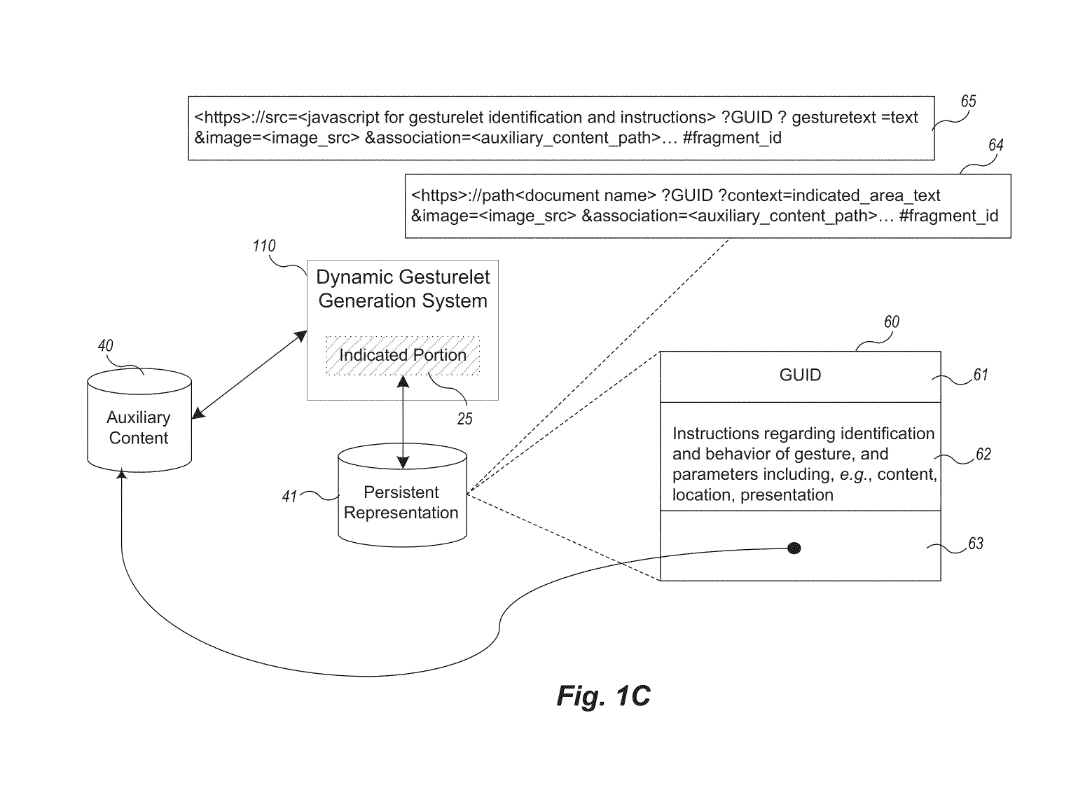

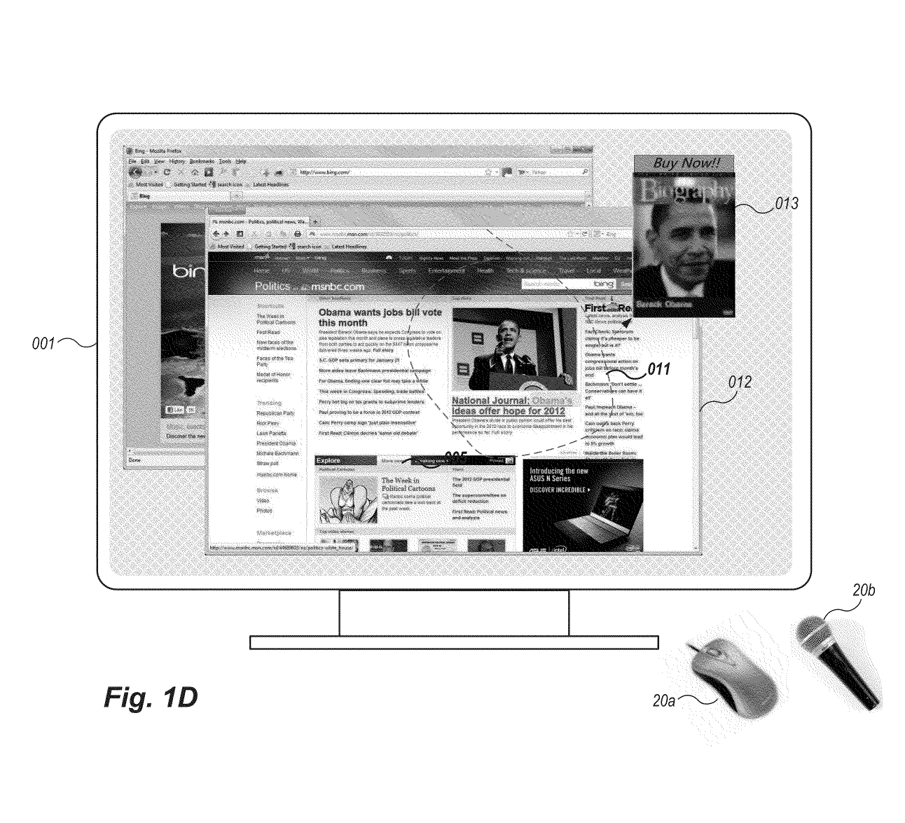

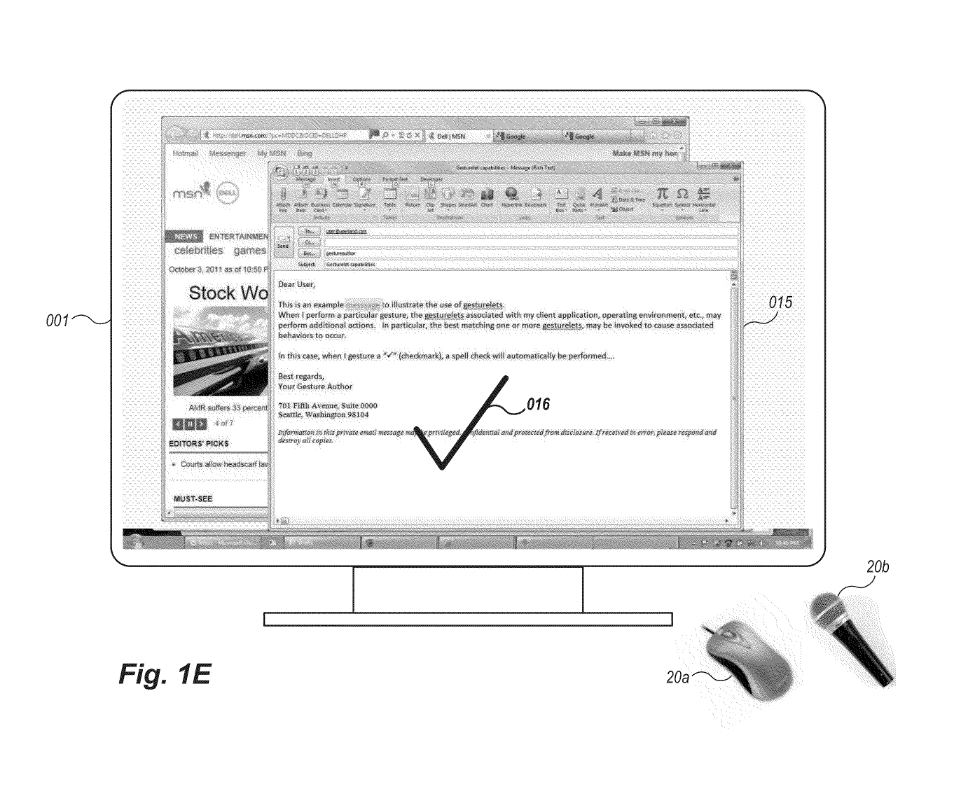

FIG. 1A is a block diagram of example use of a gesturelet produced by an example Dynamic Gesturelet Generation System (DGGS) or process. In FIG. 1A, a presentation device, such as computer display screen 001, is shown presenting two windows with electronic content, window 002 and window 003. The user (not shown) utilizes an input device, such as mouse 20a and/or a microphone 20b, to indicate a gesture (e.g., gesture 005 or gesture 006) to the DGGS. The DGGS, as will be described in detail elsewhere herein, determines to which portion of the electronic content displayed in window 002 the gesture 005 or gesture 006 corresponds, potentially including what type of gesture. Gesture 005 was created using the mouse device 20a and represents a closed path (shown in red) that is not quite a circle or oval that indicates that the user is interested in the entity “Vladimir Putin.” Gesture 006, as another example, was created using the microphone 20b by directed selection of the image of Henry Edwards along with some text regarding his span of life. The DGGS has highlighted the text 007 to which gesture 006 is determined to correspond. In the example illustrated, the DGGS generates a gesturelet (which may be implemented, for example, using a data structure stored in any type of persistent or non-persistent memory) and associates the gesturelet with auxiliary content. Here, the auxiliary content is shown as an advertised book 008 on Vladimir Putin. In this example, the DGGS presents the auxiliary content 008 overlaid on the electronic content presented in window 002.

In this sense, the gesturelet is being used as a means to navigate to auxiliary content—the book advertisement. Once the auxiliary content that is associated with the portion of the electronic content is identified (such as the indication of the advertisement 008), it may be stored as part of a persistent representation of a gesturelet. One definition of the gesturelet might provide that, in some contexts (like within this user's web browser), each time the entity “Vladimir Putin” is indicated by a gesture, then this same auxiliary content would be displayed. Alternatively, the browser may be programmed to generally process a “circle” gesture (or a closed path or nearly closed path gesture that approximates a circle) to mean—find me the most prominent entity likely indicated by the gesture and display an appropriate advertisement. Here, the portion of the electronic content is “any”—which may be represented as a wildcard, or a pointer to no specific content since the gesturelet is meant to be invoked for that gesture regardless of the content. The gesturelet itself, containing an appropriate set of identifying and executable instructions, may be capable of performing the lion share of the work—with the browser needing only to invoke its array of gesturelets to “identify yourself and do the right thing.” Both techniques may result in a display such as that shown in FIG. 1A.

In some example embodiments of the DGGS, a gesturelet is defined based upon the gesture-based input system. For example, gestures in the form of, for example, circles, ovals, polygons, and/or closed paths may be used to indicate some portion of the presented content to be formed into a gesturelet (including the gesture itself as described above). The gesture may indicate content that is contiguous or non-contiguous. Audio may also be used to indicate some area of the presented content, such as by using a spoken word, phrase, and/or direction. Other embodiments provide additional ways to indicate input by means of a gesture. The DGGS can be fitted to incorporate any technique for providing a gesture that indicates some portion (including any or all) of presented content.

Different techniques may be incorporated when the DGGS presents the auxiliary content associated with a gesturelet. For example, in some embodiments, the DGGS presents the auxiliary content overlaying the initial content. This may be presented in an animated fashion where the auxiliary content “moves into place” from one side of a presentation device. In other examples, the auxiliary content may be placed in another window, pane, frame, or the like, which may or may not be juxtaposed, overlaid, or just placed in conjunction with to the initial presented content. Other arrangements are of course contemplated.

FIG. 1B is a block diagram of an example environment for using gesturelets produced by an example Dynamic Gesturelet Generation System (DGGS) or process. One or more users 10a, 10b, etc. communicate to the DGGS 110 through one or more networks, for example, wireless and/or wired network 30, by indicating gestures using one or more input devices, for example a mobile device 20a, an audio device such as a microphone 20b, or a pointer device such as mouse 20c or the stylus on table device 20d (or for example, or any other input device, such as a keyboard of a computer device). For the purposes of this description, the nomenclature “*” indicates a wildcard (substitutable letter(s)). Thus, user 20* may indicate a device 20a or a device 20b. The one or more networks 30 may be any time of communications link, including for example, a local area network or a wide area network such as the Internet.

Gesturelets are typically generated (e.g., defined, produced, instantiated, etc.) “on-the-fly” as a user indicates, by means of a gesture, what portion of the presented content is interesting. This allows the DGGS 110 to be nimble in its responses to a user's navigation. For example, if the user is navigating among several web sites, the DGGS 110 may respond with apropos content as it follows a user's navigation. In some embodiments, the DGGS 110 may take into account other criteria in addition to the indicated portion of the presented content in order to determine what to navigate to—or what to present next, or what behavior to next perform.

The DGGS 110 determines the indicated portion 25 to which the gesture-based input corresponds, and then, based upon the indicated portion 25 and, possibly a set of criteria 50, generates a gesturelet and determines auxiliary content to be presented. The set of criteria 50 may be dynamically determined, predetermined, local to the DGGS 110, or stored or supplied externally from the DGGS 110 as described elsewhere. This set of criteria may include a variety of factors, including, for example: context of the indicated portion of the presented content, such as other words, symbols, and/or graphics nearby the indicated portion, the location of the indicated portion in the presented content, syntactic and semantic considerations, etc; attributes of the user, for example, prior search, purchase, and/or navigation history, demographic information, and the like; attributes of the gesture, for example, direction, size, shape, color, steering, and the like; and other criteria, whether currently defined or defined in the future. In this manner, the DGGS 110 allows navigation to become “personalized” to the user as much as the system is tuned.

The auxiliary content determined by the DGGS 110 may be stored local to the DGGS 110, for example, in auxiliary content data repository 40 associated with a computing system running the DGGS 110, or may be stored or available externally, for example, from another computing system 42, from third party content 43 (e.g., a 3^{rd} party advertising system, external content, a social network, etc.) from auxiliary content stored using cloud storage 44, from another device 45 (such as from a settop box, A/V component, etc.), from a mobile device connected directly or indirectly with the user (e.g., from a device associated with a social network associated with the user, etc.), and/or from other devices or systems not illustrated. Third party content 43 is demonstrated as being communicatively connected to both the DGGS 110 directly and/or through the one or more networks 30. Although not shown, various of the devices and/or systems 42-46 also may be communicatively connected to the DGGS 110 directly or indirectly. The auxiliary content may be any type of content and, for example, may include another document, an image, an audio snippet, an audio visual presentation, an advertisement, an opportunity for commercialization such as a bid, a product offer, a service offer, or a competition, and the like. Once the DGGS 110 determines the auxiliary content to present, the DGGS 110 causes the auxiliary content to be presented on a presentation device (e.g., presentation device 20d) associated with the user.

In some example embodiments of the DGGS 110, a generated gesturelet may be associated with auxiliary content so that the DGGS 110 can determine what to present in response to detection that the generated gesturelet has been selected or retrieved (e.g., the gesturelet is presented in some manner and a user selects it, or, for example, the user indicates a gesture and the “system” (client side/server side) finds and retrieves an appropriate gesturelet, or as a result of other operations).

The generated gesturelet may have a persistent representation which can be stored in a memory, for example, a computer solid state memory or a data repository such as persistent representation repository 41. A persistent data repository such as data repository 41 may be a data base, a file, an XML definition, a memory, or any other means for storing data comprising the gesturelet. The persistent representation 41 of the gesturelet may store an indication of the associated auxiliary content. Basically, an indication to any type of content that can be presented on a presentation device may be stored as part of the persistent representation of the gesturelet. In addition, the persistent representation 41 of the gesturelet may store some set of identifying information (such as the indicated portion to which the gesturelet belongs, a corresponding gesture or image, etc.) and/or instructions for determining that the gesturelet is to be processed to present the auxiliary content.

The DGGS 110 illustrated in FIG. 1B may be executing (e.g., running, invoked, or the like) on a client or on a server device or computing system. For example, a client application (e.g., a web application, web browser, other application, etc.) may be executing on one of the presentation devices, such as tablet 20d. In some embodiments, some portion or all of the DGGS 110 components may be executing as part of the client application (for example, downloaded as a plug-in, active-x component, run as a script or as part of a monolithic application, etc.). In other embodiments, some portion or all of the DGGS 110 components may be executing as a server (e.g., server application, server computing system, software as a service, etc.) remotely from the client input and/or presentation devices 20a-d.

Gesturelets need not be persistently stored to be used for navigation to auxiliary content. However, as mentioned above, gesturelets may be stored using any type of unique identification such as a GUID (Global Unique Identifier) that refers to some area of storage—persistent or volatile. In some embodiments, gesturelets are stored using Unique Resource Identifiers (URIs) or Unique Resource Locators (URLs), or using any other type of structure that may be stored in a memory (e.g., non-volatile memory such as a database, data repository, file, an XML definition, memory, or any other means for storing data).

FIG. 1C is a block diagram of example persistent representations of a gesturelet produced by an example Dynamic Gesturelet Generation System (DGGS) or process. In FIG. 1C, several example persistent representations 60, 64, and 65 of a gesturelet created by DGGS 110 are illustrated. Persistent representation 60 is shown as a record in data repository 41. The record comprises a unique identifier GUID 61, instructions 62, and an indication of auxiliary content 63, here a reference to something stored in auxiliary content data repository 40. The instructions 62 may contain information and instructions on identifying whether this gesturelet is the “best match” for handling whatever caused the gesturelet to be retrieved, instructions on what it does (including to present auxiliary content indicated by indicator 63), and one or more parameters that may assist in performance of the instructions such as, for example, identification of the indicated portion used to create the gesturelet, such as portion 25 (e.g., when the gesturelet is specific or based upon that portion), location information, presentation information, gesture attributes, or other information that is relevant to the gesturelet's presentation of auxiliary content.

For example, if the gesturelet 60 is used to provide an advertisement aligned with a specific entity (e.g., such as Vladimir Putin), then each time the entity “Vladimir Putin” is detected in a gesture, gesturelet 60 may be retrieved in order to present the appropriate advertisement. In this case the parameters 62 may include identification of the entity “Vladimir Putin” as well as perhaps instructions to highlight the entity name when encountered. The indicator of auxiliary content would then refer to the advertisement, such as ad 008 to be presented.

As another example, if the gesturelet 60 is used to provide a behavior for a type of gesture regardless of the “indicated” portion, then the instructions 62 may be directed to identifying whether the shape of the indicated gesture matches a stored shape and code for performing a next set of actions.

Other and/or different content may also be incorporated into persistent gesturelet representation structure 60.

Persistent gesturelet representations 64 and 65 illustrate that other types of data structures, such as URIs, also may be used to store/represent gesturelet information. Gesturelet representation 64 is an example URI that supports the ad gesturelet example with Vladimir Putin described above. Gesturelet representation 65 is an example URI that supports the behavior for a specific gesture shape example described above. The parameters are represented here using standard URI notation (“?”<parameter name=value>); however, it is to be understood that other formats can be incorporated. Also, the code or instructions used to implement the gesturelet behavior may be stored externally in a file (illustrated here as path<document name>) or directly in the URI itself (illustrated here as src=<javascript for gesturelet identification and instructions>) to be interpreted, for example, by the code that renders based upon the URI.

FIG. 1D is a block diagram of example use of a retrieved gesturelet produced an example Dynamic Gesturelet Generation System (DGGS) or process. In this example, a persistent gesturelet (not shown) that corresponds to the named entity “Obama” has been retrieved when the user indicates a gesture such as the closed path 011 using gesture device 20*. In this case, the persistent gesturelet is retrieved and an advertisement 013 for the latest book on the named entity “Obama,” associated with the persistent gesturelet is presented on window 012 on display screen 001. Another way to use persistent gesturelets to accomplish similar functionality is to define a persistent gesturelet for the gesture “closed path” which is not only specific to an indicated portion of presented electronic potentially used to create the gesturelet. In this case, the instructions (e.g., program, code, script, or the like) stored in the gesturelet may instruct the program (e.g., here a client side application or web browser) that caused retrieval of the gesturelet to find a “best match” advertisement that matches the most common or prominent entity encompassed by the gesture.

FIG. 1E is a block diagram of another example use of a retrieved gesturelet produced an example Dynamic Gesturelet Generation System (DGGS) or process. In this example, a persistent gesturelet (not shown) that corresponds to a checkmark gesture has been retrieved when the user indicates a gesture such as the checkmark gesture 016 on email input window 015 presented on display screen 001 using gesture device 20*. In this case the gesturelet may contain instructions for implementing a behavior specific to the checkmark gesture, such as to perform a spell check of the underlying presented content—here an email message. Further, the parameters stored in the gesturelet may adapt the behavior to do certain things or not do certain things, for example, based upon attributes of the gesture such as how big the checkmark 016 is drawn, how dark, how long the handle is, etc.

Other examples for using persistent gesturelets may be similarly incorporated.

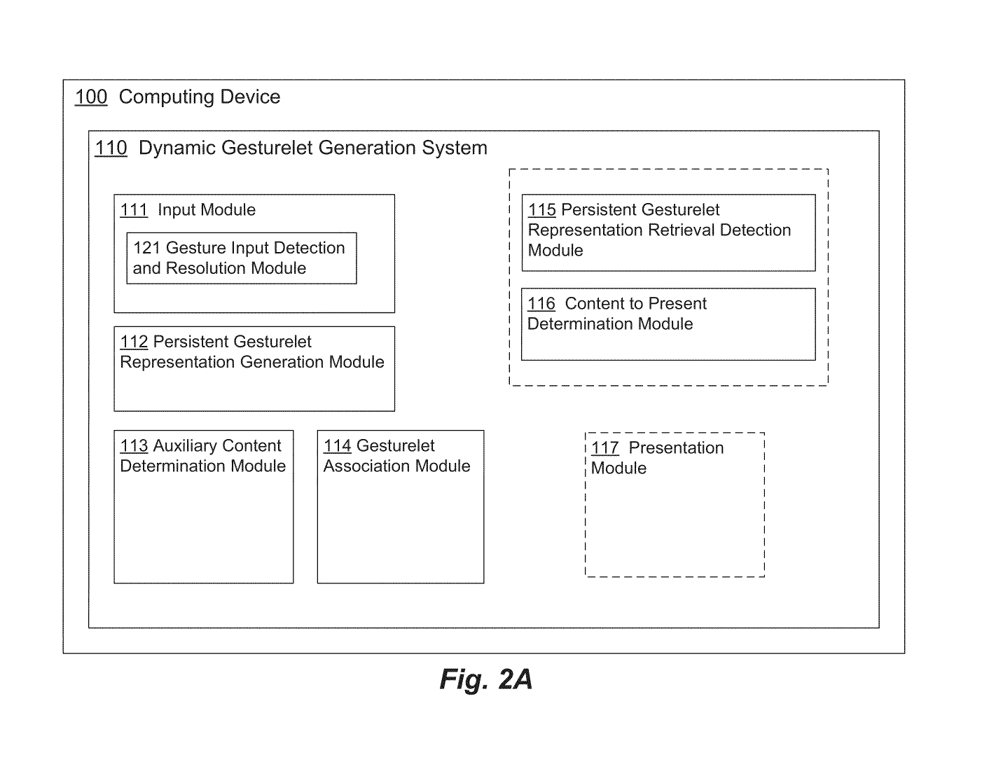

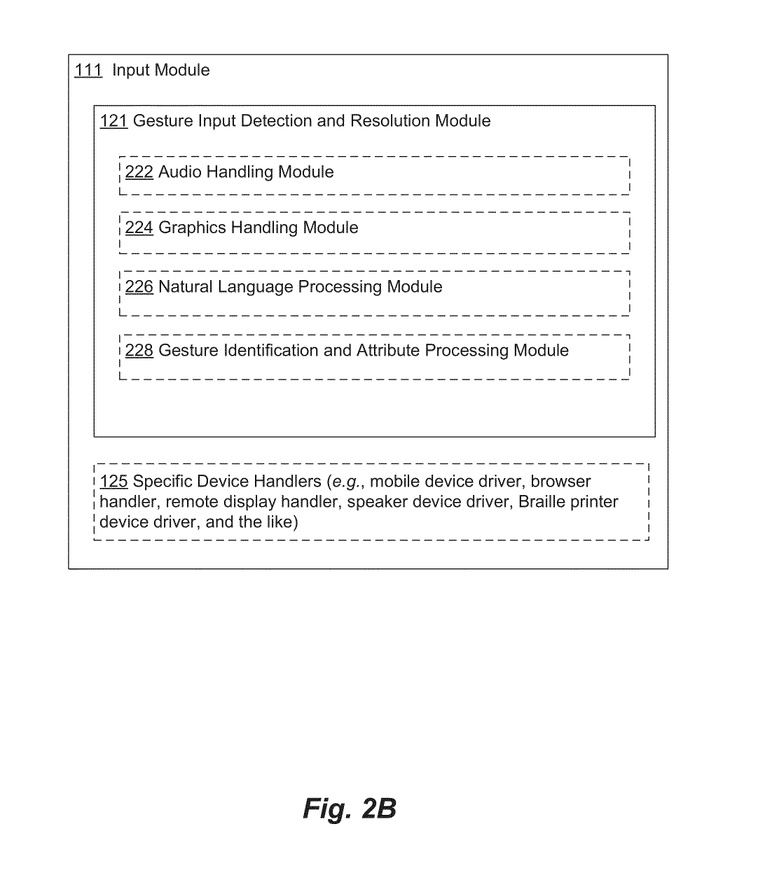

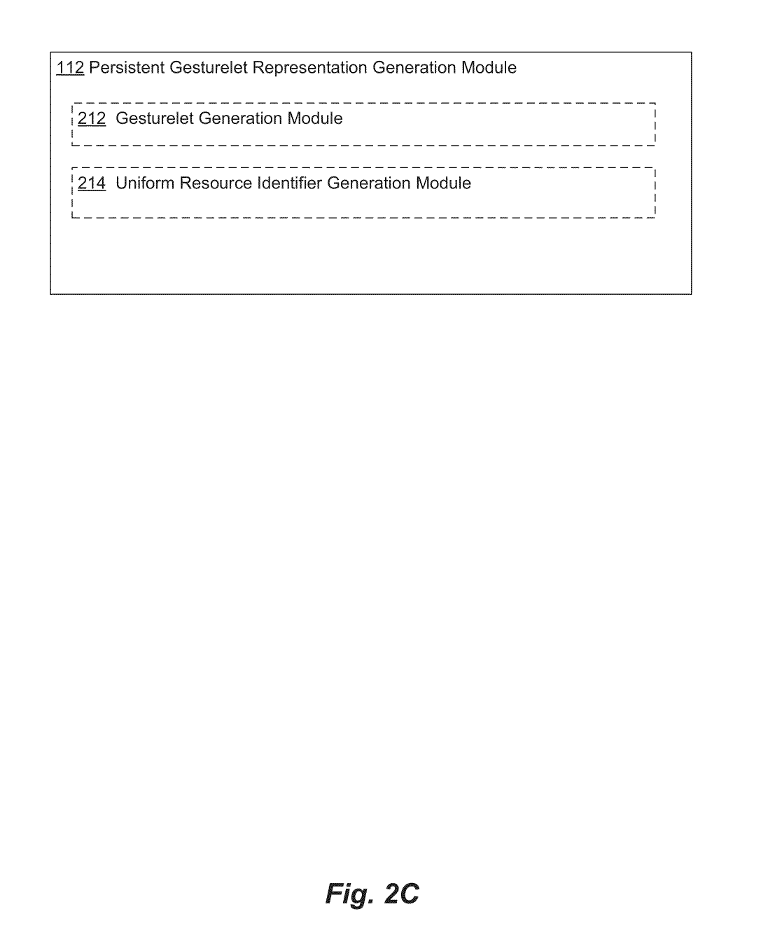

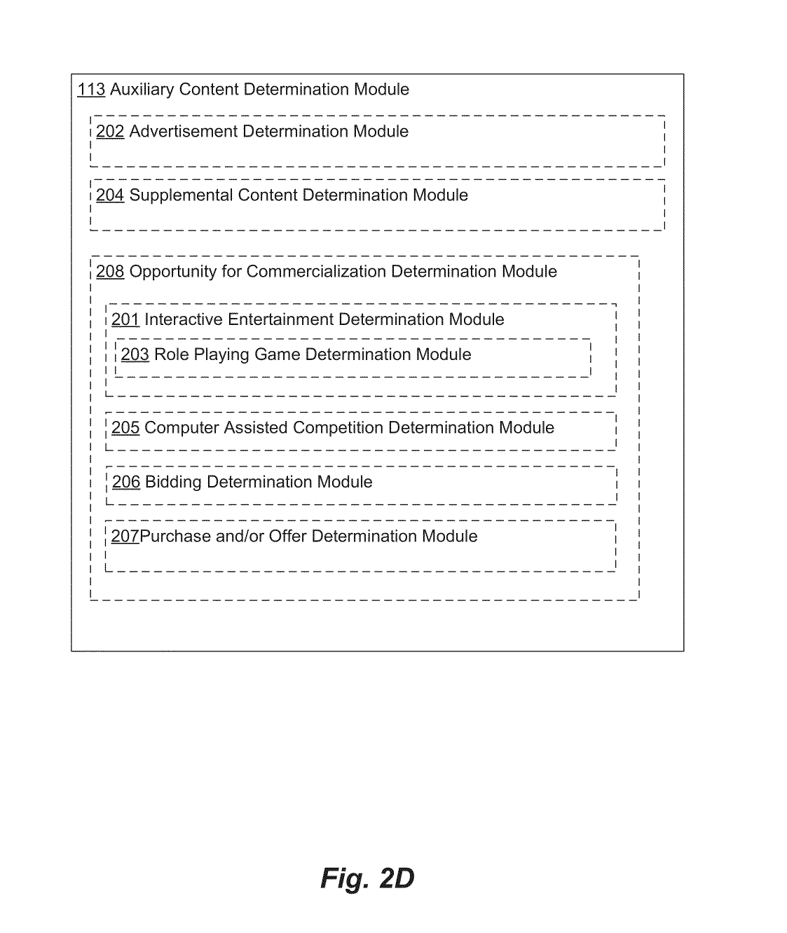

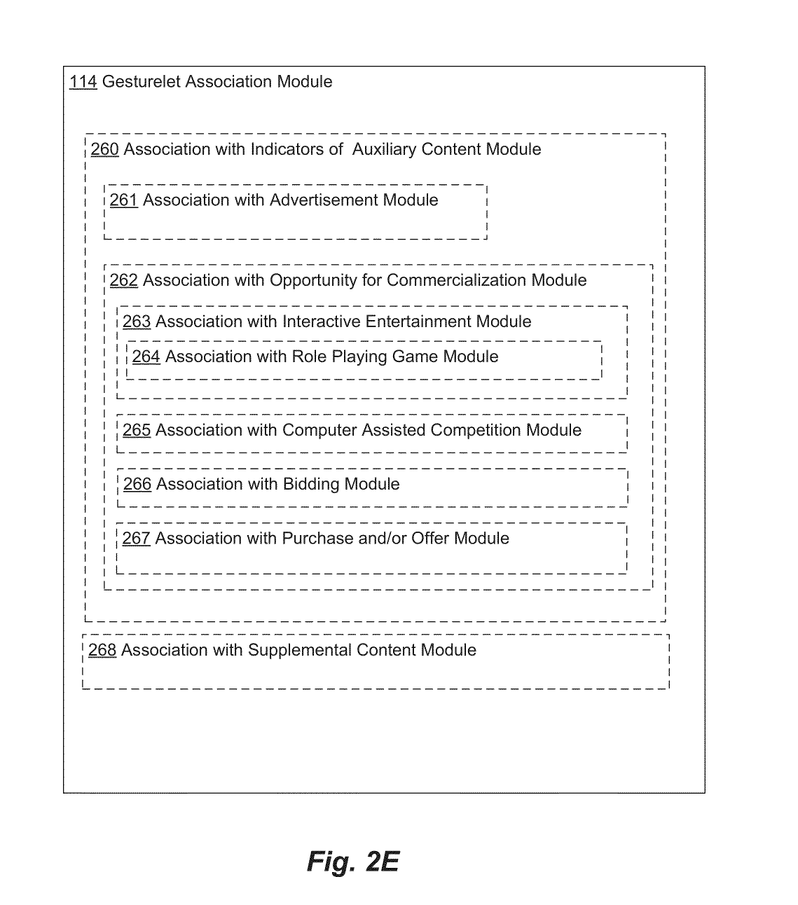

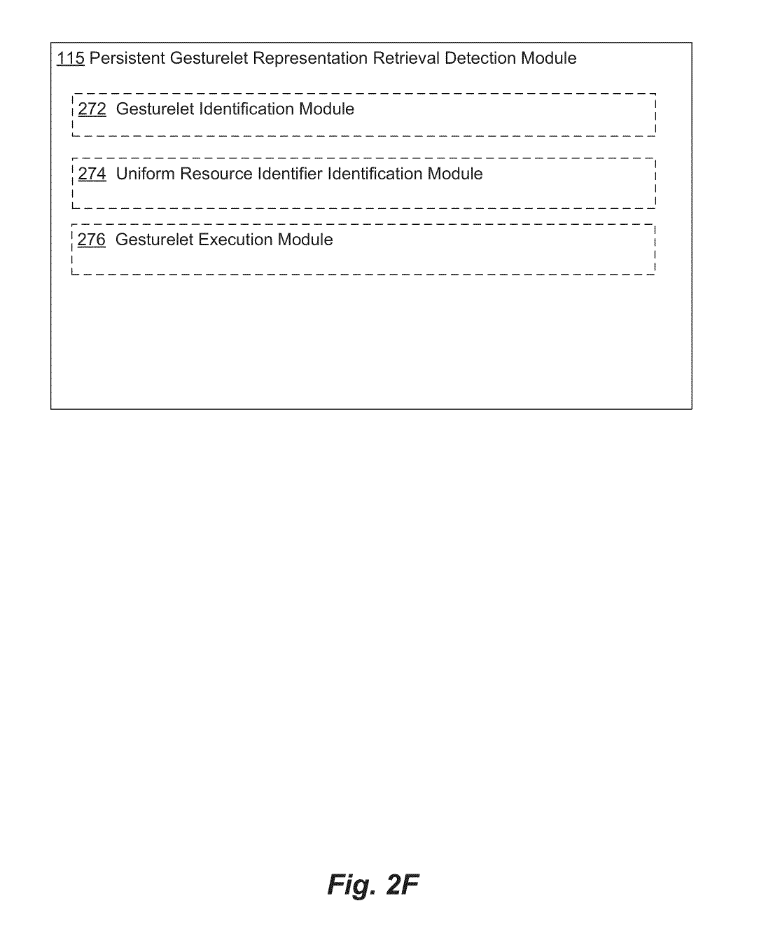

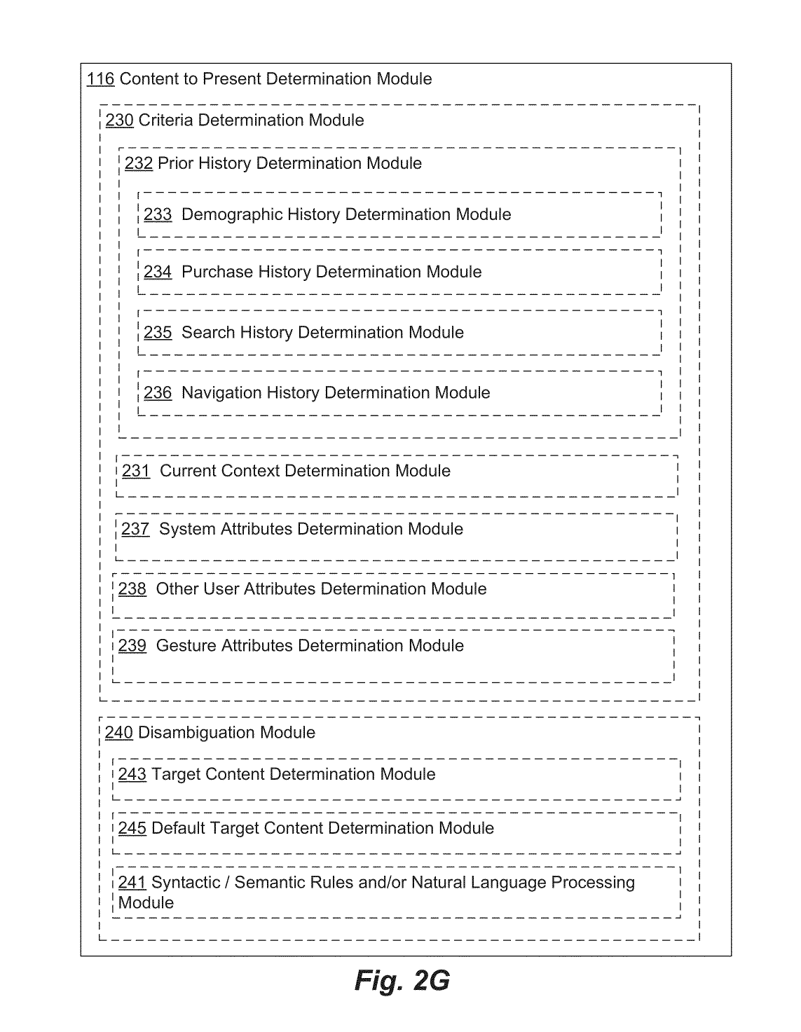

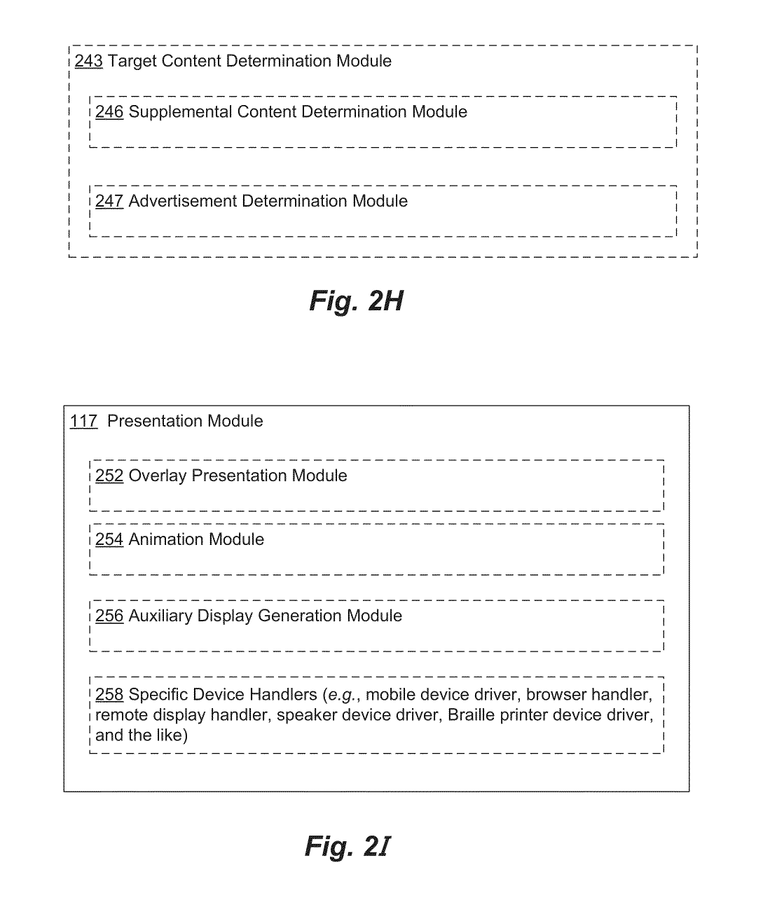

FIG. 2A is an example block diagram of components of an example Dynamic Gesturelet Generation System. In example DGGSes such as DGGS 110 of FIG. 1A, the DGGS comprises one or more functional components/modules that work together to automatically provide auxiliary content. For example, a Dynamic Gesturelet Generation System 110 may reside in (e.g., execute thereupon, be stored in, operate with etc.) a computing device 100 programmed with logic to effectuate the purposes of the DGGS 110. As mentioned, a DGGS 110 may be executed client side or server side. For ease of description, the DGGS 110 is described as though it is operating as a server. It is to be understood that equivalent client side modules can be implemented. Moreover, such client side modules need not operate in a client-server environment, as the DGGS 110 may be practiced in a standalone environment. Moreover, the DGGS 10 may be implemented in hardware, software, or firmware, or in some combination. In addition, persistent representations of gesturelets are oft described herein as executing client side. However, these can be executed server side as well. Details of the computing device/system 100 are described below with reference to FIG. 23.

In an example system, a DGGS 110 comprises an input module 111, a persistent representation generation module 112, an auxiliary content determination module 113, a gesturelet association module 114, a persistent representation retrieval detection module 115, a content to present determination module 116, and (optionally) a presentation module 117. In some embodiments the DGGS comprises additional and/or different modules as described further below.

Input module 111 is configured and responsible for determining the gesture and an indication of a portion of the presented electronic content indicated by the gesture. In some example systems, the input module 111 comprises a gesture input detection and resolution module 121 to aid in this process.

Persistent representation generation module 112 is configured and responsible for generating a persistent representation of a gesturelet generated in response to a gesture inputted using the input module 111 using the gesture input detection and resolution module 121. An auxiliary content determination module 122 is employed to determine likely auxiliary content to associate with the persistent representation as described with reference to FIGS. 1B and 1C. Once determined, the gesturelet association module 114 is invoked to associate the determine auxiliary content with the generated persistent representation of the gesturelet.

Once persistent representations of gesturelets have been generated (and stored) by persistent representation generation module 112, as described with reference to FIGS. 1A-1E, they can be retrieved in order to perform specific actions to automatically provide auxiliary content. In particular, as described above, each persistent gesturelet representation is responsible for determining whether it is been retrieved using the persistent representation retrieval detection module 115 and determining what content to present using content to present determination module 116. Although these modules are shown as part of the DGGS 110, the code to perform these operations may reside in the persistent gesturelet itself (hence the dotted line) or in a more centralized, potentially server side, component. (The intelligence is either in the stored object or in a management component that determines a best matching persistent gesturelet and retrieves it.) In any case, one the content to present determination module 116 determines what content to present (e.g., associated auxiliary content), then, optionally, forwards it (e.g., communicated, sent, pushed, etc.) to a presentation module 117 to cause the presentation module 112 to present the auxiliary content. As described above, the auxiliary content may be presented in a variety of manners, including visual display, audio display, via a Braille printer, etc., and using different techniques, for example, overlays, animation, etc.

FIG. 2B is an example block diagram of further components of the Input Module of an example Dynamic Gesturelet Generation System. In some example systems, the input module 111 may be configured to include a variety of other modules and/or logic. For example, the input module 111 may be configured to include a gesture input detection and resolution module 121 as described with reference to FIG. 2A. The gesture input detection and resolution module 121 may be further configured to include a variety of modules and logic for handling a variety of input devices and systems. For example, gesture input detection and resolution module 121 may be configured to include an audio handling module 222 for handling gesture input by way of audio devices and/or a graphics handling module 224 for handing the association of gestures to graphics in content (such as an icon, image, movie, still, sequence of frames, etc.). In addition, in some example systems, the input module 111 may be configured to include a natural language processing (NLP) module 226. NLP module 226 may be used, for example, to detect whether a gesture is meant to indicate a word, a phrase, a sentence, a paragraph, or some other portion of presented electronic content using techniques such as syntactic and/or semantic analysis of the content. In some example systems, the input module 111 may be configured to include a gesture identification and attribute processing module 228 for handling other aspects of gesture determination such as determining the particular type of gesture (e.g., a circle, polygon, closed path, check mark, box, or the like) or whether a particular gesture is a “steering” gesture that is meant to correct, for example, an initial path indicated by a gesture, a “smudge” which may have its own interpretation, the color of the gesture, for example, if the input device supports the equivalent of a colored “pen” (e.g., pens that allow a user can select blue, black, red, or green), size of a gesture (e.g., whether the gesture draws a thick or thin line, whether the gesture is a small or large circle, and the like), and/or other attributes of a gesture.

Other modules and logic may be also configured to be used with the input module 111.

FIG. 2C is an example block diagram of further components of the Persistent Gesturelet Representation Generation Module of an example Dynamic Gesturelet Generation System. In some example systems, the persistent gesturelet representation generation module 112 may be configured to include a variety of other modules and/or logic. For example, the persistent representation generation module 112 may be configured to include a gesturelet generating module for generating a gesturelet, including a GUID, instructions and/or parameters, and an association as illustrated with respect to FIG. 1C. As noted, a gesturelet may be stored in any appropriate data structure that can store these data elements including an indication of the associated auxiliary content. In some example systems, a gesturelet is generated using a uniform resource identifier (URI) or uniform resource locator (URL). A uniform resource identifier generation module 204 may be configured to be included in such systems to aid in the generation of URIs that can be configured as persistent gesturelets.

FIG. 2D is an example block diagram of further components of the Auxiliary Content Determination Module of an example Dynamic Gesturelet Generation System. In some example systems, the DGGS 110 may be configured to include an auxiliary content determination module 113 to determine (e.g., find, establish, select, realize, resolve, establish, etc.) auxiliary or supplemental content for the persistent representation of the gesturelet. The auxiliary content determination module 113 may be further configured to include a variety of different modules to aid in this determination process. For example, the auxiliary content determination module 113 may be configured to include an advertisement determination module 202 to determine one or more advertisements that can be associated with the current gesturelet. For example, as shown in FIG. 1B, these advertisements may be provided by a variety of sources including from local storage, over a network (e.g., wide area network such as the Internet, a local area network, a proprietary network, an Intranet, or the like), from a known source provider, from third party content (available, for example from cloud storage or from the provider's repositories), and the like. In some systems, a third party advertisement provider system is used that is configured to accept queries for advertisements (“ads”) such as using keywords, to output appropriate advertising content.

In some example systems the auxiliary content determination module 113 is further configured to provide a supplemental content determination module 204. The supplemental content determination module 204 may be configured to determine other content that somehow relates to (e.g., associated with, supplements, improves upon, corresponds to, has the opposite meaning from, etc.) the content associated with the gesturelet.

In some example systems the auxiliary content determination module 113 is further configured to provide an opportunity for commercialization determination module 208 to find a commercialization opportunity appropriate for the gesturelet. In some such systems, the commercialization opportunities may include events such as purchase and/or offers, and the opportunity for commercialization determination module 208 may be further configured to include an interactive entertainment determination module 201, which may be further configured to include a role playing game determination module 203, a computer assistant competition determination module 205, a bidding determination module 206, and a purchase and/or offer determination module 207 with logic to aid in determining a purchase and/or an offer as auxiliary content for a gesturelet. Other modules and logic may be also configured to be used with the auxiliary content determination module 113.

FIG. 2E is an example block diagram of further components of the Gesturelet Association Module of an example Dynamic Gesturelet Generation System. In some example systems, the DGGS 110 may be configured to include an gesturelet association module 114 to associate (e.g., bind, refer to, cross-reference, etc.) auxiliary content determined by the auxiliary content determination module 113 for the persistent representation of the gesturelet. The gesturelet association module 114 may be further configured to include a variety of different modules to aid in this association process. For example, gesturelet association module 114 may be configured to include an association with indicators of auxiliary content module 260 and an association with supplement content module 268. In some embodiments, the association with indicators of auxiliary content module 260 is further configured to include an association with advertisement module 261 which associates the gesturelet with an advertisement and an association with opportunity for commercialization module 262. As described above, the association with opportunity for commercialization module 262 may comprise a variety of modules specific to the type of commercial opportunity: an associate with interactive entertainment module 263 for associating the gesturelet with some kind of interactive entertainment, (for example, a puzzle, a quiz, etc.); an association with computer assisted competition module 265 for associating the gesturelet with some type of computer assisted competition; an association with bidding module 266; and/or an association with a purchase and/or offer module 267. In many embodiments, the determination is made using the auxiliary content determination module 113 and associated with the persistent representation of the gesturelet using the gesturelet association module 114. In other embodiments the determination and association of the auxiliary content is performed by the same module. Other modules and logic may be also configured to be used with the auxiliary content determination module 113.

FIG. 2F is an example block diagram of further components of the Persistent Gesturelet Representation Retrieval Detection Module of an example Dynamic Gesturelet Generation System. In some example systems, the persistent gesturelet representation retrieval detection module 115 may be configured to include a variety of other modules and/or logic. For example, the persistent gesturelet representation retrieval detection module 115 may be configured to include a gesturelet identification module 272, a uniform resource identifier identification module 274, and a gesturelet execution module 276.

In some embodiments, the gesturelet identification module 272 comprises instructions that allow the gesturelet to determine whether it is a “best match” for the gesture and/or indicated portion of the presented electronic content. For example, as described with respect to FIGS. 1C-1E, in some embodiments the gesturelets may determine whether the gesture being performed (for example, the checkmark in FIG. 1D) is something the gesturelet provides behavior for—spell checking for example. In some embodiments, the gesturelets may examine the indicated portion of the electronic content (e.g., a phrase, for example, the entity name “Vladimir Putin”) and determine whether the gesturelet has instructions to handle this entity, for example, by presenting an associated advertisement.

In some embodiments the actual behavior implemented by the gesturelet may be provided by a gesturelet execution module 276. In other embodiments, the gesturelet may just inform calling (e.g., invoking, outer nested, surrounding, etc.) code that the correct gesturelet has been identified and leave the behavior implementation to the surrounding code.

The uniform resource identifier identification module 274 may be invoked, for example, by the gesturelet identification module 272, to determine aspects of the gesturelet, such as identification code, used to determine whether a particular gesturelet has been retrieved (and identified) as the best matching gesturelet to handle the current gesture and/or indicated portion. A separate code module 274 allows the definition of the URI used to store information to be changed and incorporated by just replacing, extending, modifying, etc. the uniform resource identifier identification module 274.

FIG. 2G is an example block diagram of further components of the Content to Present Determination Module of an example Dynamic Gesturelet Generation System. In some example systems, the content to present determination module 116 may be configured to include a variety of other modules and/or logic. For example, the content to present determination module 116 may be configured to include a criteria determination module 230 and a disambiguation module 240, both used to determine what content to present based upon other criteria (e.g., in addition to the base gesture) including possibly disambiguating between multiple choices using the disambiguation module 240. For example, the persistent representation of the gesturelet may have instructions that result in the gesturelet being associated with a variety of content. Based upon this additional criteria and/or disambiguation capabilities, the persistent gesturelet determines what content is appropriate to present.

In some example systems, the criteria determination module 230 may be configured to include a prior history determination module 232, a system attributes determination module 237, other user attributes determination module 238, a gesture attributes determination module 239, and/or current context determination module 231. In some example systems, the prior history determination module 232 determines (e.g., finds, establishes, selects, realizes, resolves, establishes, etc.) prior histories associated with the user and is configured to include modules/logic to implement such. For example, the prior history determination module 232 may be configured to include a demographic history determination module 233 that is configured to determine demographics (such as age, gender, residence location, citizenship, languages spoken, or the like) associated with the user. The prior history determination module 232 may be configured to include a purchase history determination module 234 that is configured to determine a user's prior purchases. The purchase history may be available electronically, over the network, may be integrated from manual records, or some combination. In some systems, these purchases may be product and/or service purchases. The prior history determination module 232 may be configured to include a search history determination module 235 that is configured to determine a user's prior searches. Such records may be stored locally with the DGGS 110 or may be available over the network or using a third party service, etc. The prior history determination module 232 also may be configured to include a navigation history determination module 236 that is configured to keep track of and/or determine how a user navigates through his or her computing system so that the DGGS 110 can determine aspects such as navigation preferences, commonly visited content (for example, commonly visited websites or bookmarked items), etc.

The criteria determination module 230 may be configured to include a system attributes determination module 237 that is configured to determine aspects of the “system” that may provide influence or guidance (e.g., may inform) the determination of which auxiliary content is appropriate for the portion of content indicated by a “matching” retrieved gesturelet. These may include aspects of the DGGS 110, aspects of the system that is executing the DGGS (e.g., the computing system 100), aspects of a system associated with the DGGS 110 (e.g., a third party system), network statistics, and/or the like.

The criteria determination module 230 may be configured to include other user attributes determination module 238 that is configured to determine other attributes associated with the user not covered by the prior history determination module 232. For example, a user's social connectivity data may be determined by module 238.

The criteria determination module 230 may be configured to include a gesture attributes determination module 239. The gesture attributes determination module 239 is configured to provide determinations of attributes of the gesture input, similar or different from those described relative to input module 111 and gesture attribute processing module 228 for determining to what content a gesture corresponds. Thus, for example, the gesture attributes determination module 239 may provide information and statistics regarding size, length, shape, color, and/or direction of a gesture.

The criteria determination module 230 may be configured to include a current context determination module 231. The current context determination module 231 is configured to provide determinations of attributes regarding what the user is viewing, the underlying content, context relative to other containing content (if known), whether the gesture has selected a word or phrase that is located with certain areas of presented content (such as the title, abstract, a review, and so forth). Other modules and logic may be also configured to be used with the criteria determination module 230.

As mentioned, the content to present determination module 116 may be configured also to include a disambiguation module 240. The disambiguation module 240 is configured to aid in the selection of auxiliary content when, for example, the meaning of the portion of content indicated by the gesturelet is perhaps unclear and/or when, for example, more than one possibility of auxiliary content is determined by the auxiliary content determination module 113 for possible presentation (such as, for example, when the instructions of the persistent gesturelet translate to “find an appropriate auxiliary content” or “find an appropriate advertisement,” or the like).

In some example systems, the disambiguation module 240 is configured to include a default target content determination module 243. The target content determination module 243 is configured to provide “default” auxiliary content using default auxiliary content module 245 that relates to a gesturelet. This may be helpful, for example, when the auxiliary content determination module 113 does not return useful (or any) results. In some example systems, the default auxiliary content may be presented to the user for possible selection, alone or in addition to results determined by the auxiliary content determination module 113.

In some example systems, the disambiguation module 240 is configured to include a syntactic/semantic rules and/or NLP module 247. This module is configured to assist in disambiguating whether particular auxiliary content determined by the auxiliary content determination module 113 actual relates to the portion of content indicated by the gesturelet. This may occur as explained above when a word or phrase (or image) implicated by the gesturelet may have more than one meaning. The DGGS 110 performs a type of “just in time” disambiguation (like late binding) in that the DGGS 110 may not resolve a potentially ambiguous indication of content, as indicated by the gesturelet, until it determines that more than one type of possible auxiliary content was found. Any sort of syntactic and/or semantic processing that is useful to disambiguate words, phrases, text, etc. may be incorporated into module 247.

FIG. 2H is an example block diagram of further components of the Target Content Determination Module of an example Dynamic Gesturelet Generation System. In some example systems, the default target content determination module is configured to assist in determining auxiliary content using an advertisement determination module 247 and/or a supplemental content determination module 246. The advertisement determination module 247 helps determine a target content when the realm of possibilities includes some type of advertisement. The supplemental content determination module 246 assists in determining other types of target content.

Other modules and logic may be also configured to be used with the content to present determination module 116.

FIG. 2I is an example block diagram of further components of the Presentation Module of an example Dynamic Gesturelet Generation System. In some example systems, the presentation module 117 may be configured to include a variety of other modules and/or logic. For example, the presentation module 117 may be configured to include an overlay presentation module 252 for determined how to present auxiliary content determined by the content to present determination module 116 on a presentation device, such as tablet 20d. Overlay presentation module 252 may utilize knowledge of the presentation devices to decide how to integrate the auxiliary content as an “overlay” (e.g., covering up a portion or all of the underlying presented content). For example, when the DGGS 110 is run as a server application that serves web pages to a client side web browser, certain configurations using “html” commands or other tags may be used.

Presentation module 117 also may be configured to include an animation module 254. In some example systems, the auxiliary content may be “moved in” from one side or portion of a presentation device in an animated manner. For example, the auxiliary content may be placed in a pane (e.g., a window, frame, pane, etc., as appropriate to the underlying operating system or application running on the presentation device) that is moved in from one side of the display onto the content previously shown (a form of navigation to the auxiliary content). Other animations can be similarly incorporated.

Presentation module 117 also may be configured to include an auxiliary display generation module 256 for generating a new graphic or audio construct to be presented in conjunction with the content already displayed on the presentation device. In some systems, the new content is presented in a new window, frame, pane, or other auxiliary display construct.

Presentation module 117 also may be configured to include specific device handlers 258, for example device drivers configured to communicate with mobile devices, remote displays, speakers, Braille printers, and/or the like. Other or different presentation device handlers may be similarly incorporated.

Also, other modules and logic may be also configured to be used with the presentation module 117.

Although the techniques of a DGGS are generally applicable to any type of gesture-based system, the phrase “gesture” is used generally to imply any type of physical pointing type of gesture or audio equivalent. In addition, although the examples described herein often refer to online electronic content such as available over a network such as the Internet, the techniques described herein can also be used by a local area network system or in a system without a network. In addition, the concepts and techniques described are applicable to other input and presentation devices. Essentially, the concepts and techniques described are applicable to any environment that supports some type of gesture-based input.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a Dynamic Gesturelet Generation System (DGGS) to be used for automatically providing auxiliary content. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the scope of the techniques and/or functions described are not limited by the particular order, selection, or decomposition of steps described with reference to any particular routine.

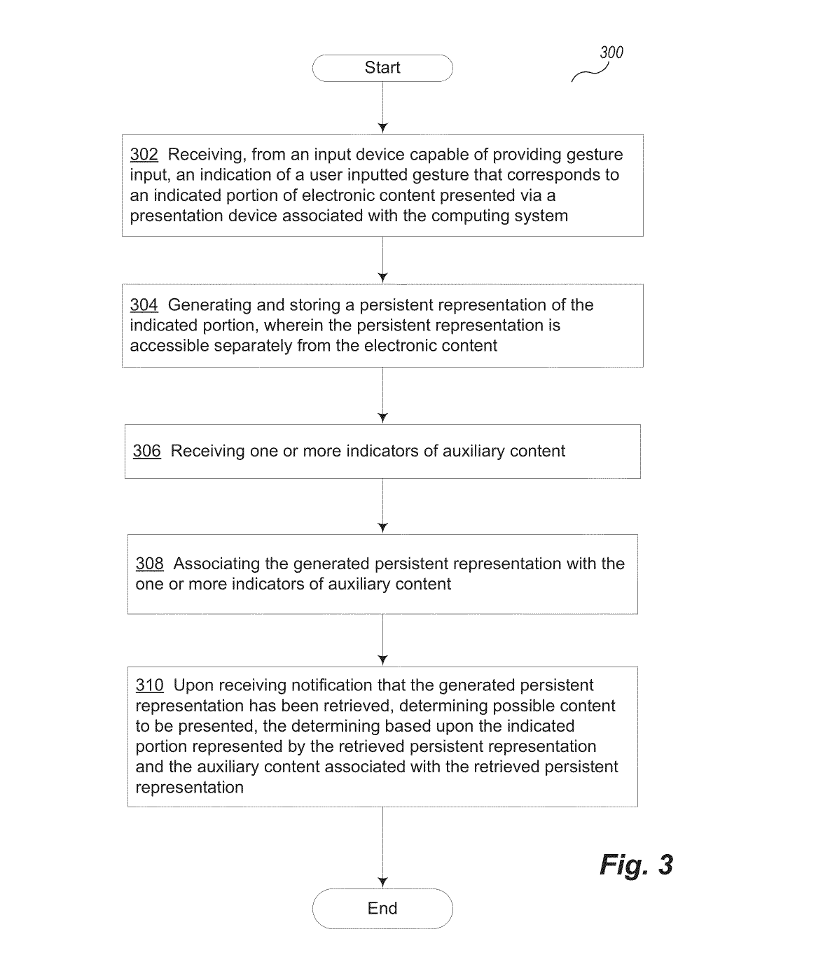

FIGS. 3-15 include example flow diagrams of various example logic that may be used to implement embodiments of a Dynamic Gesturelet Generation System (DGGS). The example logic will be described with respect to the example components of example embodiments of a DGGS as described above with respect to FIGS. 1A-2I. However, it is to be understood that the flows and logic may be executed in a number of other environments, systems, and contexts, and/or in modified versions of those described. In addition, various logic blocks (e.g., operations, events, activities, or the like) may be illustrated in a “box-within-a-box” manner. Such illustrations may indicate that the logic in an internal box may comprise an optional example embodiment of the logic illustrated in one or more (containing) external boxes. However, it is to be understood that internal box logic may be viewed as independent logic separate from any associated external boxes and may be performed in other sequences or concurrently.

FIG. 3 is an example flow diagram of example logic for automatically providing auxiliary content. Operational flow 300 includes several operations. In operation 302, the logic performs receiving, from an input device capable of providing gesture input, an indication of a user inputted gesture that corresponds to an indicated portion of electronic content presented via a presentation device associated with the computing system. This logic may be performed, for example, by the input module 111 of the DGGS 110 described with reference to FIG. 2A by receiving (e.g., obtaining, getting, extracting, and so forth), from an input device capable of providing gesture input (e.g., devices 20*), an indication of a user inputted gesture that corresponds to an indicated portion (e.g., indicated portion 25) on electronic content presented via a presentation device (e.g., 20*) associated with the computing system 100. One or more of the modules provided by the gesture input detection and resolution module 121, including the audio handling module 222, graphics handling module 224, natural language processing module 226, and/or gesture attribute processing module 228 may be used to assist in operation 302.

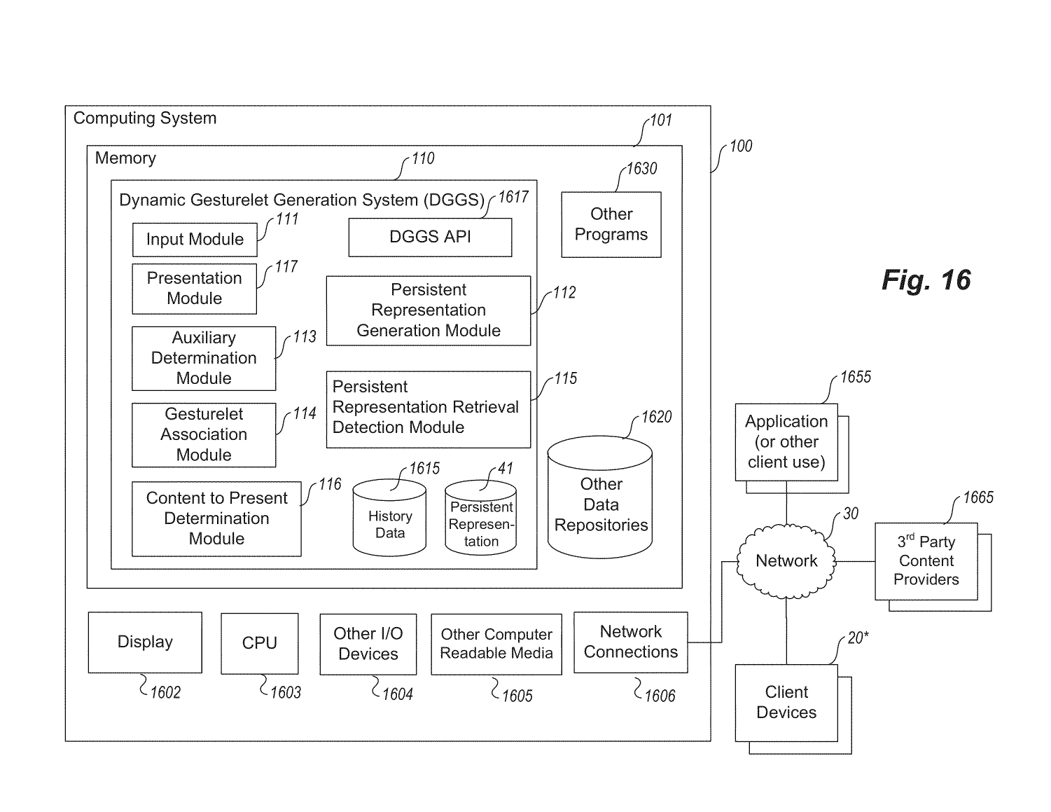

In operation 304, the logic performs generating and storing a persistent representation of the indicated portion, wherein the persistent representation is accessible separately from the electronic content. This logic may be performed, for example, by the persistent gesturelet representation generation module 112 of the DGGS 110 described with reference to FIGS. 2A and 2C by generating a representation of the indicated portion (e.g., portion 25) in memory (e.g., memory 101 in FIG. 16).

In operation 306, the logic performs receiving one or more indicators of auxiliary content. This logic may be performed, for example, by the auxiliary content determination module 113 of the DGGS 110 described with reference to FIGS. 2A and 2D by determining (e.g., obtaining, eliciting, receiving, designating, etc.) one or more indicators of possible auxiliary content. As is described elsewhere, depending upon the type of content, different additional modules, such as the modules illustrated in FIG. 2D, may be utilized to assist in determining the auxiliary content. Indicators may take many forms, including for example, pointers, named content, instructions, code, algorithms, or other types of references to the auxiliary content.

In operation 308, the logic performs associating the generated persistent representation with the one or more indicators of auxiliary content. This logic may be performed, for example, by the gesturelet association module 114 of the DGGS 110 described with reference to FIGS. 2A and 2E by associating (e.g., pairing, referencing, communicating, relating, connecting, correlating, combining, uniting, linking, and the like) the persistent representation generated in operation 304 with the one or more indicators received in operation 306. As is described elsewhere, depending upon the type of auxiliary content, different additional modules, such as the modules illustrated in FIG. 2E, may be utilized to assist in associating the one or more indicators of auxiliary content to the generated persistent representation.

In operation 310, the logic performs upon receiving notification that the generated persistent representation has been retrieved, determining possible content to be presented, the determining based upon the indicated portion represented by the retrieved persistent representation and the auxiliary content associated with the retrieved persistent representation. This logic may be performed, for example, by the persistent gesturelet representation retrieval detection module 115 in concert with the content to present determination module 116 of the DGGS 110 described with reference to FIGS. 2A, 2F, and 2G. As described elsewhere, these modules may reside in the persistent gesturelet that is being retrieved or external to the gesturelet. The modules 115 and 116 may determine what possible content to be presented based upon the indicated portion represented by the retrieved persistent representation (e.g., a phrase, image, text, etc., or nothing) and the associated auxiliary content (e.g., an advertisement, instructions, image, web page, document, and the like).

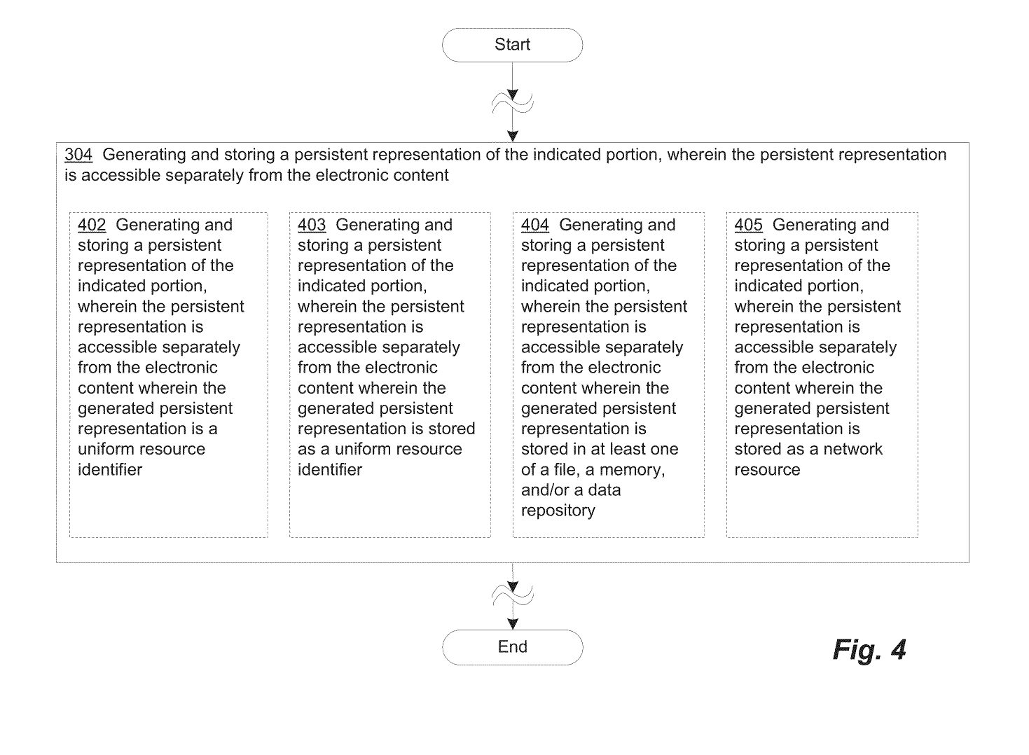

FIG. 4 is an example flow diagram of example logic illustrating various example embodiments of block 304 of FIG. 3. In some embodiments, the logic of operation 304 for generating and storing a persistent representation of the indicated portion, wherein the persistent representation is accessible separately from the electronic content may include an operation 402 whose logic specifies wherein the generated persistent representation is a uniform resource identifier. The logic of operation 402 may be performed, for example, by the gesturelet generation module 212 and the uniform resource identifier generation module 214 of the persistent gesturelet representation generation module 112 of the DGGS 110 described with reference to FIGS. 2A and 2C.

In the same or different embodiments, operation 304 may include an operation 403 whose logic specifies wherein the generated persistent representation is stored as a uniform resource identifier. The logic of operation 403 may be performed, for example, by the gesturelet generation module 212 and the uniform resource identifier generation module 214 of the persistent gesturelet representation generation module 112 of the DGGS 110 described with reference to FIGS. 2A and 2C.

In the same or different embodiments, operation 304 may include an operation 404 whose logic specifies wherein the generated persistent representation is stored in at least one of a file, a memory, and/or a data repository. The logic of operation 404 may be performed, for example, by the gesturelet generation module 212 of the persistent gesturelet representation generation module 112 of the DGGS 110 described with reference to FIGS. 2A and 2C. The file, memory, and/or data repository may be stored, for example, in persistent representation data repository 41 in FIG. 1B.

In the same or different embodiments, operation 304 may include an operation 405 whose logic specifies wherein the generated persistent representation is stored as a network resource. The logic of operation 404 may be performed, for example, by the gesturelet generation module 212 of the persistent gesturelet representation generation module 112 of the DGGS 110 described with reference to FIGS. 2A and 2C. The network resource may be stored, for example, in persistent representation data repository 41 in FIG. 1B.

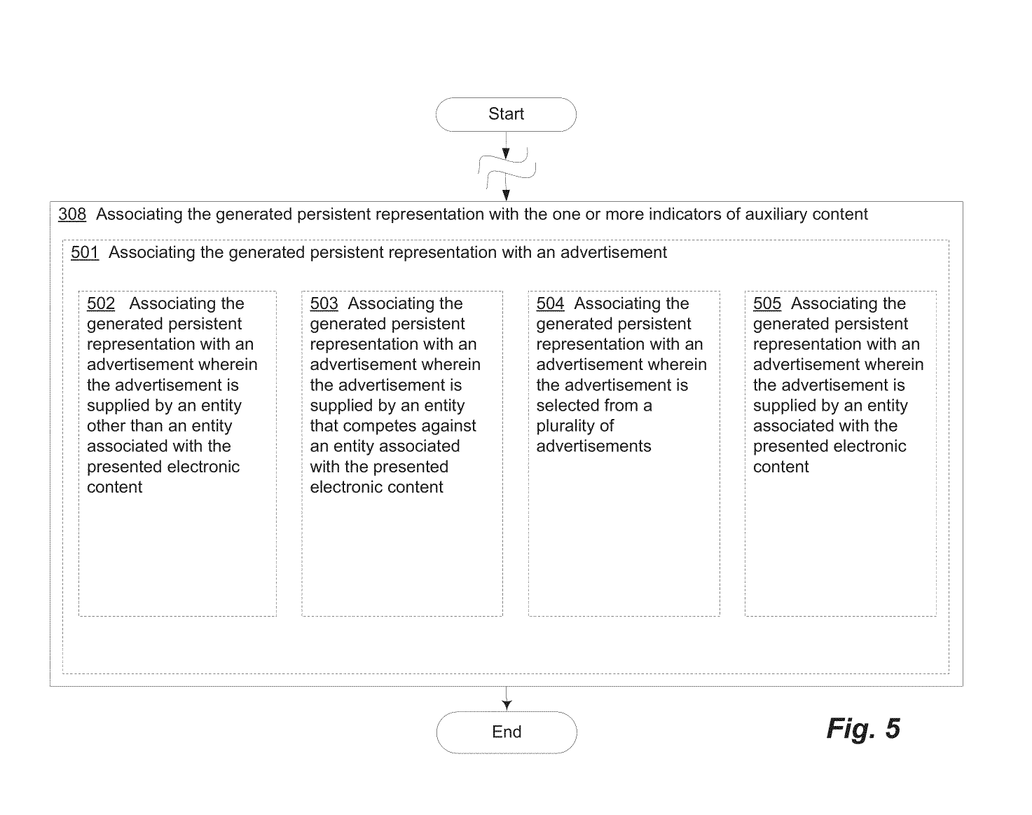

FIG. 5 is an example flow diagram of example logic illustrating various example embodiments of block 308 of FIG. 3. In some embodiments, the logic of operation 308 for associating the generated persistent representation with the one or more indicators of auxiliary content may include an operation 501 whose logic specifies associating the generated persistent representation with an advertisement. The logic of operation 501 may be performed, for example, by the association with advertisement module 261 provided by the association with indicators of auxiliary content module 260, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with an advertisement, such as advertisement example 008 in FIG. 1A.

In some embodiments, operation 501 may further include an operation 502 whose logic specifies wherein the advertisement is supplied by an entity other than an entity associated with the presented electronic content. The logic of operation 502 may be performed, for example, by the association with advertisement module 261 provided by the association with indicators of auxiliary content module 260, provided by the gesturelet association module 114 of DGGS 110 as described with reference to FIGS. 2A and 2E by obtaining an advertisement from, for example, one of the providers remote to the computing system 100 (e.g., one of providers 42-46 described with reference to FIG. 1B).

In some embodiments, operation 501 may further include an operation 503 whose logic specifies wherein the advertisement is supplied by an entity that competes against an entity associated with the presented electronic content. The logic of operation 503 may be performed, for example, by the association with advertisement module 261 provided by the association with indicators of auxiliary content module 260, provided by the gesturelet association module 114 of DGGS 110 as described with reference to FIGS. 2A and 2E by obtaining an advertisement from a remote provided. For example, one of the providers remote to the computing system 100 (e.g., one of providers 42-46 described with reference to FIG. 1B) may be one that competes against an entity associated with the presented electronic content.

In some embodiments, operation 501 may further include an operation 504 whose logic specifies wherein the advertisement is selected from a plurality of advertisements. The logic of operation 504 may be performed, for example, by the association with advertisement module 261 provided by the association with indicators of auxiliary content module 260, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with one of a plurality of advertisements. As described with reference to FIG. 2E, third party auxiliary content provider 43 may be configured, for example, as a third party ad provider that provides one or more advertisements that match an input query, for example, a set of keywords.

In some embodiments, operation 501 may further include an operation 505 whose logic specifies wherein the advertisement is supplied by an entity associated with the presented electronic content. The logic of operation 504 may be performed, for example, by the association with advertisement module 261 provided by the association with indicators of auxiliary content module 260, provided by the gesturelet association module 114 of DGGS 110 as described with reference to FIGS. 2A and 2E. For example, the advertisement may come from auxiliary content 40 or from cloud storage 44 (see FIG. 1B).

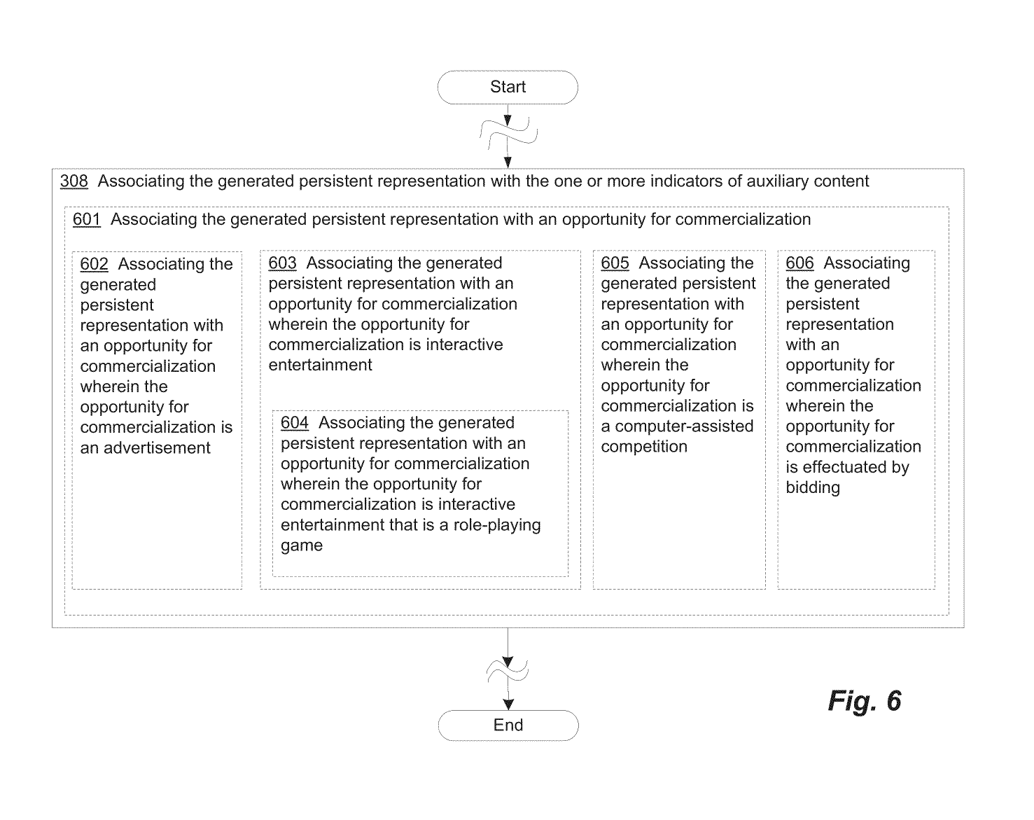

FIG. 6 is an example flow diagram of example logic illustrating various example embodiments of block 308 of FIG. 3. In some embodiments, the logic of operation 308 for associating the generated persistent representation with the one or more indicators of auxiliary content may include an operation 601 whose logic specifies associating the generated persistent representation with an opportunity for commercialization. The logic of operation 601 may be performed, for example, by the association with opportunity for commercialization module 262 provided by the association with indicators of auxiliary content module 260, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with something that can be commercialized, such as an advertisement, an offer, a bid, a certificate, products, services, or the like.

In some embodiments, operation 601 may further include operation 602 whose logic specifies wherein the opportunity for commercialization is an advertisement. The logic of operation 602 may be performed, for example, by the association with opportunity for commercialization module 262 and/or the association with advertisement module 261 provided by the association with indicators of auxiliary content module 260, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with an advertisement such as that shown in FIG. 1A.

In the same or different embodiments, operation 601 may further include operation 603 whose logic specifies wherein the opportunity for commercialization is interactive entertainment. The logic of operation 603 may be performed, for example, by the association with interactive entertainment module 263 provided by the association with opportunity for commercialization module 262 provided by the association with indicators of auxiliary content module 260, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with some sort of interactive entertainment (e.g., a computer game, an on-line quiz show, a lottery, a movie to watch, and so forth).

In some embodiments, operation 603 may further include operation 604 whose logic specifies wherein the interactive entertainment is a role-playing game. The logic of operation 604 may be performed, for example, by the association with role playing game module 264 provided by the association with interactive entertainment module 263, provided by the association with opportunity for commercialization module 262, provided by the association with indicators of auxiliary content module 260, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with a role-playing game. The role playing game may be a multi-player online role playing game (MMRPG) or a standalone, single or multi-player role playing game, or some other form of online, manual, or other role playing game.

In the same or different embodiments, operation 601 may include operation 605 whose logic specifies wherein the opportunity for commercialization is a computer-assisted competition. The logic of operation 605 may be performed, for example, by the association with computer assisted competition module 265 provided by the association with opportunity for commercialization module 262, provided by the association with indicators of auxiliary content module 260, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with some type of computer assisted competition. The competition could be outside of the computing system as long as it is somehow assisted by a computer.

In the same or different embodiments, operation 601 may include operation 606 whose logic specifies wherein the opportunity for commercialization is effectuated by bidding. The logic of operation 605 may be performed, for example, by the association with bidding module 266 provided by the association with opportunity for commercialization module 262, provided by the association with indicators of auxiliary content module 260, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with some type of bidding opportunity, computer based, computer-assisted, and/or manual.

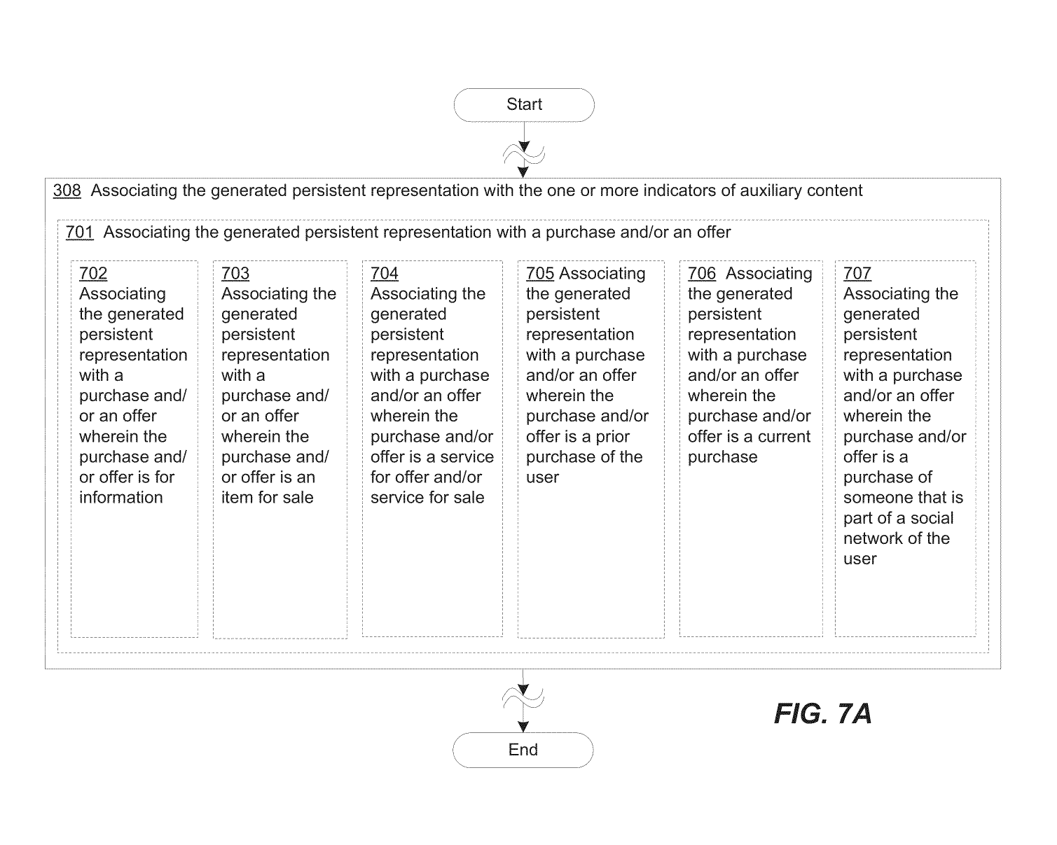

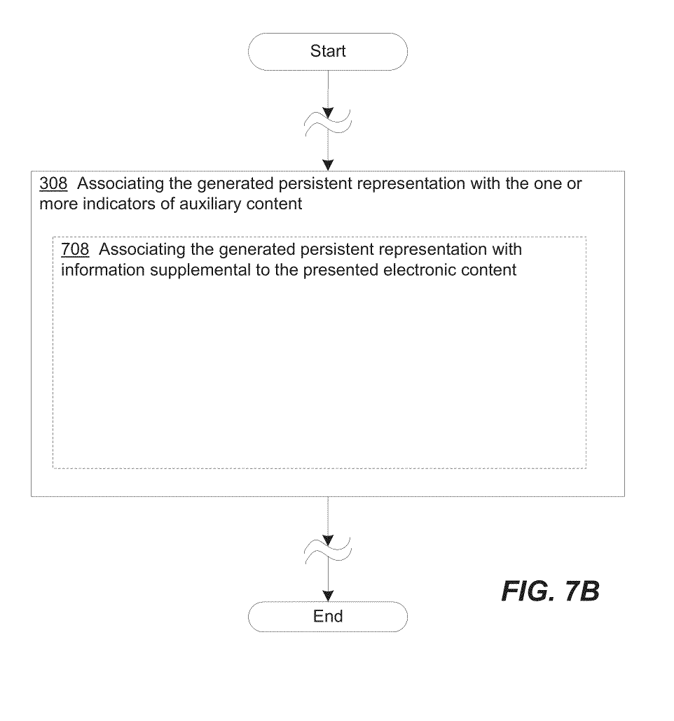

FIG. 7A is an example flow diagram of example logic illustrating various example embodiments of block 308 of FIG. 3. In some embodiments, the logic of operation 308 for associating the generated persistent representation with the one or more indicators of auxiliary content may include an operation 701 whose logic specifies associating the generated persistent representation with a purchase and/or an offer. The logic of operation 701 may be performed, for example, by the association with purchase and/or offer module 267, provided by the association with opportunity for commercialization module 262 provided by the association with indicators of auxiliary content module 260, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with some type of purchase and/or offer for purchase of information, a product, service, or the like.

In the same or different embodiments, operation 701 may include operation 702 whose logic specifies that purchase and/or an offer is for information. The logic of operation 702 may be performed, for example, by the association with purchase and/or offer module 267, provided by the association with opportunity for commercialization module 262 provided by the association with indicators of auxiliary content module 260, provided by the gesturelet association module 114 of DGGS 110 as described with reference to FIGS. 2A and 2E by generating a representation of the indicated portion (e.g., portion 25) in memory (e.g., memory 101 in FIG. 16) and associating the representation with a purchase and/or offer for purchase of information. Any type of information can be offered and/or purchased in this manner.

In the same or different embodiments, operation 701 may include an operation 703 whose logic specifies that purchase and/or an offer is an item for sale. The logic of operation 703 may be performed, for example, by the association with purchase and/or offer module 267, provided by the association with opportunity for commercialization module 262 provided by the association with indicators of auxiliary content module 260, provided by the gesturelet association module 114 of DGGS 110 as described with reference to FIGS. 2A and 2E by generating a representation of the indicated portion (e.g., portion 25) in memory (e.g., memory 101 in FIG. 16) and associating the representation with a purchase and/or offer for sale of an item. Any item, online or not, may be purchased.

In the same or different embodiments, operation 701 may include an operation 704 whose logic specifies that purchase and/or an offer is a service for offer and/or a service for sale. The logic of operation 704 may be performed, for example, by the association with purchase and/or offer module 267, provided by the association with opportunity for commercialization module 262 provided by the association with indicators of auxiliary content module 260, provided by the gesturelet association module 114 of DGGS 110 as described with reference to FIGS. 2A and 2E by generating a representation of the indicated portion (e.g., portion 25) in memory (e.g., memory 101 in FIG. 16) and associating the representation with a purchase or sale of any type of service, machine generated or human generated. If human generated the association is to a computer representation of the human generated service, for example, a contract or a calendar reminder.

In the same or different embodiments, operation 701 may include an operation 705 whose logic specifies that purchase and/or an offer is a prior purchase of the user. The logic of operation 705 may be performed, for example, by the association with purchase and/or offer module 267, provided by the association with opportunity for commercialization module 262 provided by the association with indicators of auxiliary content module 260, provided by the gesturelet association module 114 of DGGS 110 as described with reference to FIGS. 2A and 2E by generating a representation of the indicated portion (e.g., portion 25) in memory (e.g., memory 101 in FIG. 16) and associating the representation with a prior purchase of the user. Prior purchase information may be stored local to the DGGS 110, or may be available over the one or more networks 30.

In the same or different embodiments, operation 701 may include an operation 706 whose logic specifies that purchase and/or an offer is a current purchase. The logic of operation 706 may be performed, for example, by the association with purchase and/or offer module 267, provided by the association with opportunity for commercialization module 262 provided by the association with indicators of auxiliary content module 260, provided by the gesturelet association module 114 of DGGS 110 as described with reference to FIGS. 2A and 2E by generating a representation of the indicated portion (e.g., portion 25) in memory (e.g., memory 101 in FIG. 16) and associating the representation with a purchase currently underway, possibly as part of the presented content.

In the same or different embodiments, operation 701 may include an operation 707 whose logic specifies that purchase and/or an offer is a purchase of someone that is part of a social network of the user. The logic of operation 707 may be performed, for example, by the association with purchase and/or offer module 267, provided by the association with opportunity for commercialization module 262 provided by the association with indicators of auxiliary content module 260, provided by the gesturelet association module 114 of DGGS 110 as described with reference to FIGS. 2A and 2E by generating a representation of the indicated portion (e.g., portion 25) in memory (e.g., memory 101 in FIG. 16) and associating the representation with a purchase of someone that belongs to a social network associated with the user, for example through the one or more networks 30.

FIG. 7B is an example flow diagram of example logic illustrating various example embodiments of block 308 of FIG. 3. In the same or different embodiments, the logic of operation 308 for associating the generated persistent representation with the one or more indicators of auxiliary content may include an operation 708 whose logic specifies associating the generated persistent representation with information supplemental to the presented electronic content. The logic of operation 708 may be performed, for example, by the association with supplemental content module 268, provided by the gesturelet association module 114 of DGGS 110 as described with reference to FIGS. 2A and 2E by generating a representation of the indicated portion (e.g., indicated portion) in memory (e.g., memory 101 in FIG. 16) and associating the representation with any type of supplemental content, including, for example, a web page, a document, a phrase, a URI, a purchase offer, an advertisement, an image, a video, an audio snippet, or any type of content that is capable of representation.

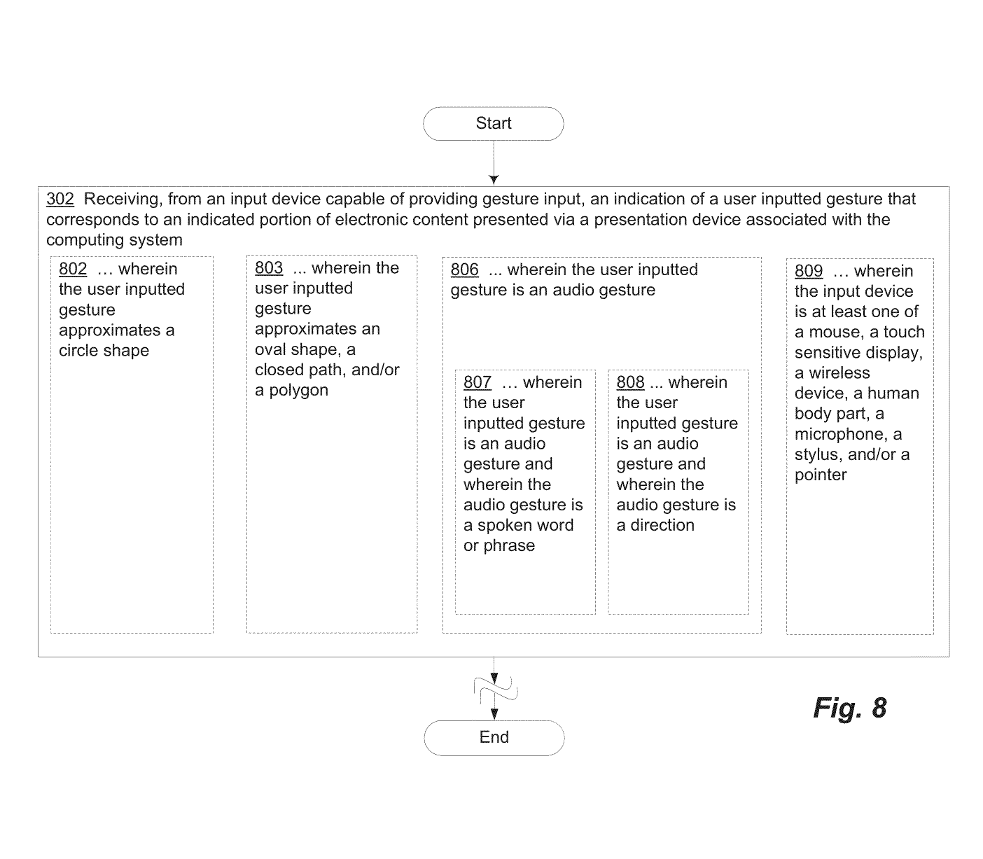

FIG. 8 is an example flow diagram of example logic illustrating various example embodiments of block 302 of FIG. 3. In the some embodiments, the logic of operation 302 for receiving, from an input device capable of providing gesture input, an indication of a user inputted gesture that corresponds to an indicated portion of electronic content presented via a presentation device associated with the computing system may include an operation 802 whose logic specifies user inputted gesture approximates a circle shape. The logic of operation 802 may be performed, for example, by the graphics handling module 224 provided by the gesture input detection and resolution module 121 provided by the input module 111 of the DGGS 110 described with reference to FIGS. 2A and 2B to detect whether a received gesture is in a form that approximates a circle shape.

In the same or different embodiments, operation 302 may include an operation 803 whose logic specifies that user inputted gesture approximates at least one of an oval shape, a closed path, and/or a polygon. The logic of operation 1603 may be performed, for example, by the graphics handling module 224 provided by the gesture input detection and resolution module 121 provided by the input module 111 of the DGGS 110 described with reference to FIGS. 2A and 2B to detect whether a received gesture is in a form that approximates an oval shape, a closed path, and/or a polygon.

In the same or different embodiments, operation 302 may include an operation 806 whose logic specifies that user inputted gesture is an audio gesture. The logic of operation 806 may be performed, for example, by the audio handling module 222 provided by the gesture input detection and resolution module 121 provided by the input module 111 of the DGGS 110 described with reference to FIGS. 2A and 2B to detect whether a received gesture is an audio gesture, such as received via audio device, microphone 20b.

In some embodiments, operation 806 may further include an operation 807 whose logic specifies that audio gesture is a spoken word or phrase. The logic of operation 807 may be performed, for example, by the audio handling module 222 provided by the gesture input detection and resolution module 121 provided by the input module 111 of the DGGS 110 described with reference to FIGS. 2A and 2B to detect whether a received audio gesture, such as received via audio device, microphone 20b, indicates (e.g., designates or otherwise selects) a word or phrase indicating some portion of the presented content.

In some embodiments, operation 806 may further include an operation 808 whose logic specifies that audio gesture is a direction. The logic of operation 808 may be performed, for example, by the audio handling module 222 provided by the gesture input detection and resolution module 121 provided by the input module 111 of the DGGS 110 described with reference to FIGS. 2A and 2B to detect a direction received from an audio input device, such as audio input device 20b. The direction may be a single letter, number, word, phrase, or any type of instruction or indication of where to move a cursor or locator device.

In the same or different embodiments, operation 302 may further include an operation 809 whose logic specifies that input device is at least one of a mouse, a touch sensitive display, a wireless device, a human body part, a microphone, a stylus, and/or a pointer. The logic of operation 809 may be performed, for example, by the specific device handlers 125 in conjunction with the gesture input detection and resolution module 121 provided by the input module 111 of the DGGS 110 described with reference to FIGS. 2A and 2B to detect and resolve input from an input device 20*.

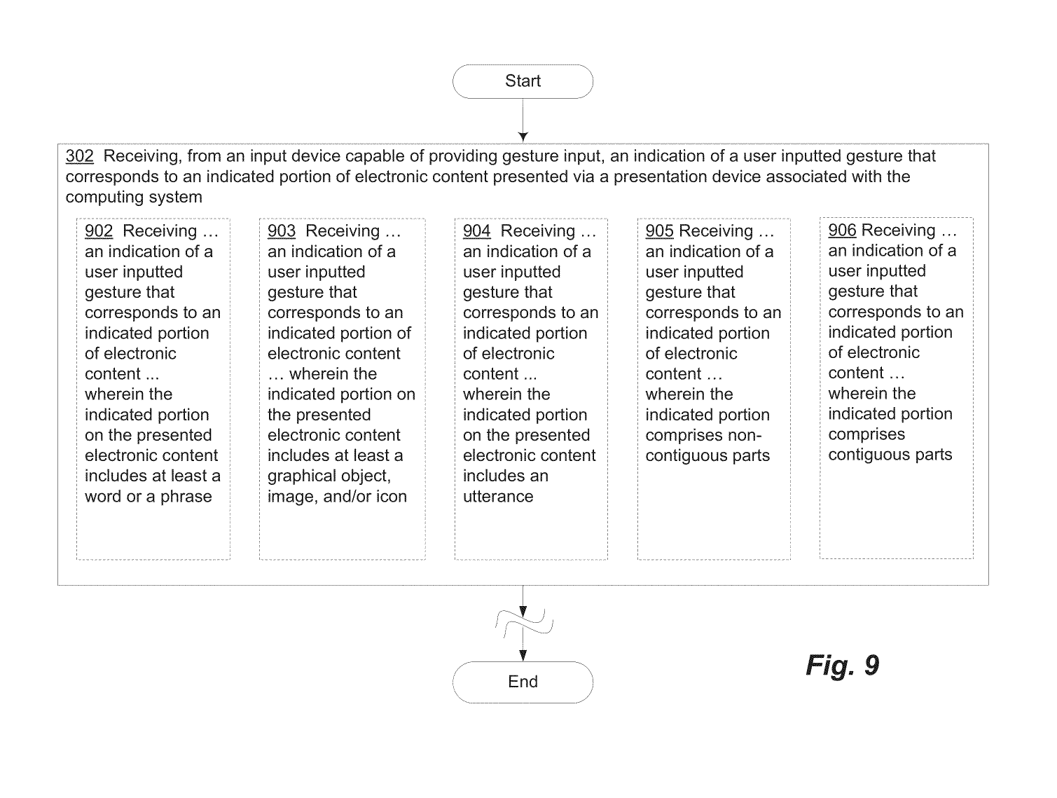

FIG. 9 is an example flow diagram of example logic illustrating various example embodiments of block 302 of FIG. 3. In the some embodiments, the logic of operation 302 for receiving, from an input device capable of providing gesture input, an indication of a user inputted gesture that corresponds to an indicated portion of electronic content presented via a presentation device associated with the computing system may include an operation 902 whose logic specifies the indicated portion of the presented electronic content includes at least a word or a phrase The logic of operation 902 may be performed, for example, by the natural language processing module 226 provided by the gesture input and resolution module 121 provided by the input module 111 of the DGGS 110 described with reference to FIGS. 2A and 2B to detect and resolve gesture input from, for example, devices 20*. In this case, the module 226 may be used to decipher word or phrase boundaries when, for example, the user 10* designates a circle, oval, polygon, closed path, etc. gesture that does not really map one to one with one or more words. Other attributes of the document and the user's prior navigation history may influence the ultimate word or phrase detected by the gesture input and resolution module 121.

In the same or different embodiments, operation 302 may include an operation 903 whose logic specifies that indicated portion of the presented electronic content includes at least a graphical object, image, and/or icon. The logic of operation 903 may be performed, for example, by the gesture input and resolution module 121 provided by the input module 111 of the DGGS 110 described with reference to FIGS. 2A and 2B to detect and resolve gesture input from, for example, devices 20*.

In the same or different embodiments, operation 302 may include an operation 904 whose logic specifies that indicated portion of the presented electronic content includes an utterance. The logic of operation 904 may be performed, for example, by the audio handling module 222 provided by the gesture input and resolution module 121 provided by the input module 111 of the DGGS 110 described with reference to FIGS. 2A and 2B to detect an utterance such as received from audio device microphone 20b.

In the same or different embodiments, operation 302 may include an operation 905 whose logic specifies that indicated portion of the presented electronic content comprises non-contiguous parts. The logic of operation 905 may be performed, for example, by the gesture input and resolution module 121 provided by the input module 111 of the DGGS 110 described with reference to FIGS. 2A and 2B to detect whether multiple portions of the presented content are indicated by the user as gestured-input. This may occur, for example, if the gesture is initiated using an audio device or using a pointing device capable of cumulating discrete gestures.

In the same or different embodiments, operation 302 may include an operation 906 whose logic specifies that indicated portion of the presented electronic content comprises contiguous parts. The logic of operation 906 may be performed, for example, by the gesture input and resolution module 121 provided by the input module 111 of the DGGS 110 described with reference to FIGS. 2A and 2B to detect whether multiple portions of the presented content are indicated by the user as gestured-input. This may occur, for example, if the gesture is initiated using an audio device or using a pointing device capable of cumulating gestures in, for example, an extended selection fashion.

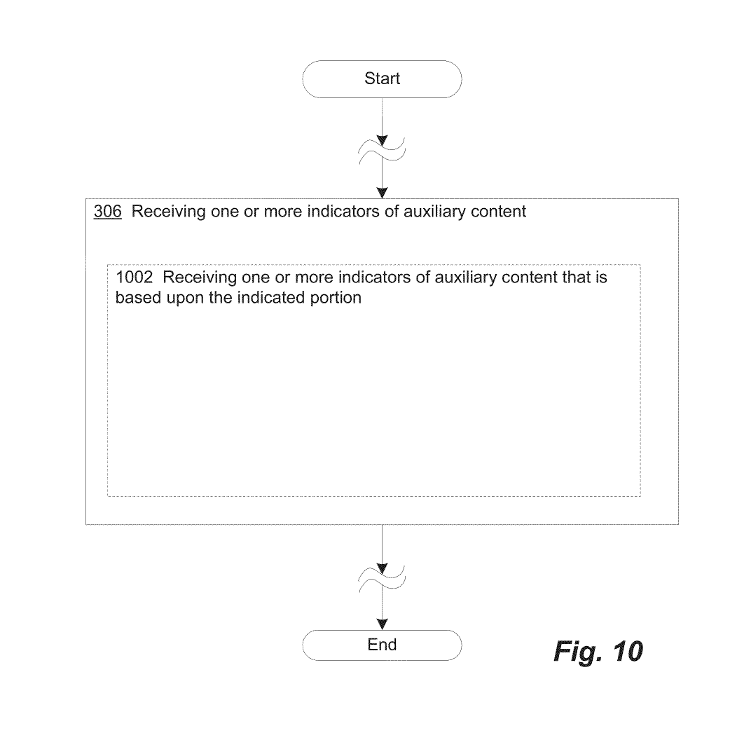

FIG. 10 is an example flow diagram of example logic illustrating various example embodiments of block 306 of FIG. 3. In the some embodiments, the logic of operation 306 for receiving one or more indicators of auxiliary content may include an operation 1002 whose logic specifies the receiving one or more indicators of auxiliary content that is based upon the indicated portion. The logic of operation 1002 may be performed, for example, by the auxiliary content determination module 113 of the DGGS 110 described with reference to FIGS. 2A and 2D to determine one or more indicators to some type of auxiliary content. In this case, the various modules of the auxiliary content determination module 113, namely the advertisement determination module 202, the supplement content determination module 204, the opportunity for commercialization determination module (with the interactive entertainment determination module 210 and the role playing game determination module 203), the computer assisted competition determination module 205, the bidding determination module 206, and the purchase and/or offer determination module 207, may be used to determine the indicators to the various types of auxiliary content. Additional and/or different modules may be similarly incorporated.

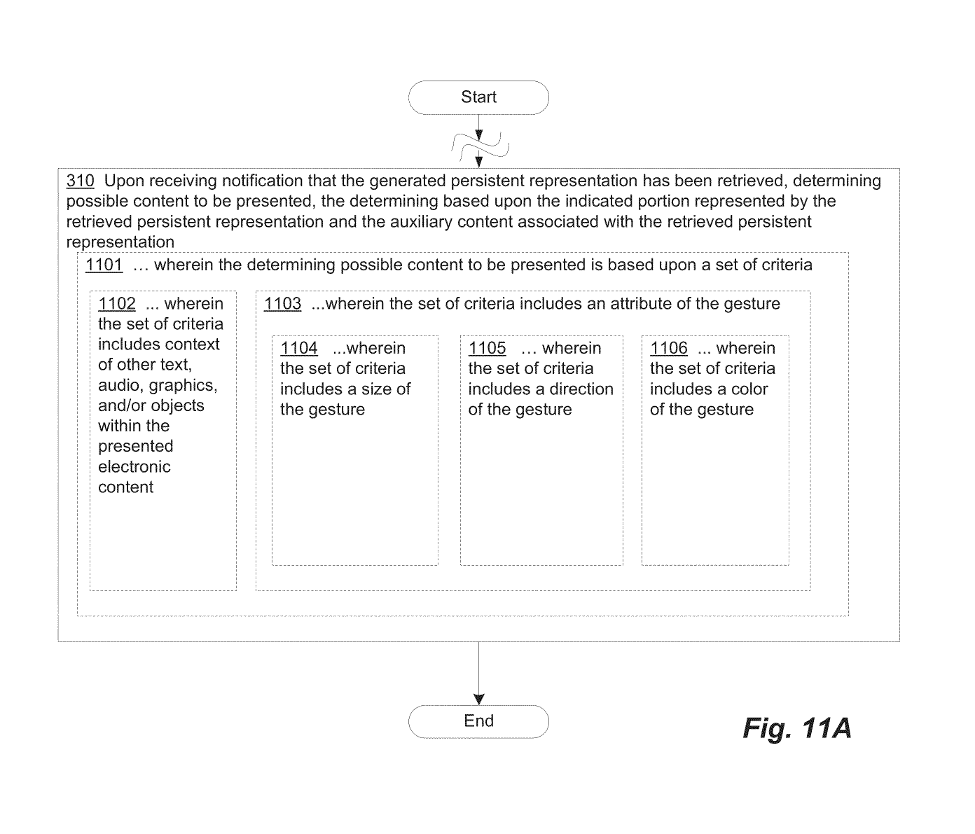

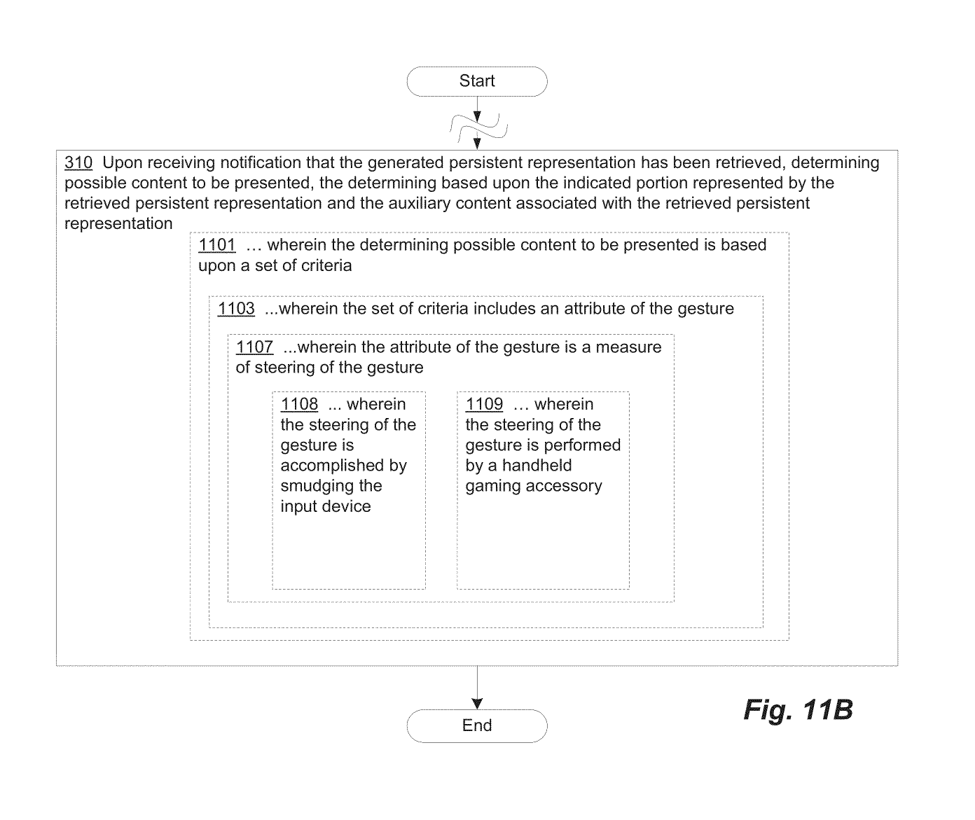

FIG. 11A is an example flow diagram of example logic illustrating various example embodiments of block 310 of FIG. 3. In some embodiments, the logic of operation 310 for upon receiving notification that the generated persistent representation has been retrieved, determining possible content to be presented, the determining based upon the indicated portion represented by the retrieved persistent representation and the auxiliary content associated with the retrieved persistent representation may include operation 1101 whose logic specifies that determining possible content to be presented is based upon a set of criteria. The logic of operation 1101 may be performed, for example, by the criteria determination module 230 provided by the content to present determination module 116 of the DGGS 110 described with reference to FIGS. 2A and 2G to determine (e.g., retrieve, designate, resolve, etc.) context related information from a variety of types of criteria, including, for example, prior history, current context information, system attributes, other user attributes, gesture attributes, or the like.

In the same or different embodiments, operation 1101 may further include an operation 1102 whose logic specifies that set of criteria includes context of other text, graphics, and/or objects within the presented electronic content. The logic of operation 1102 may be performed, for example, by the current context determination module 231 provided by the criteria determination module 116 of the DGGS 110 described with reference to FIGS. 2A and 2G to determine context related information from attributes of the electronic content.

In the same or different embodiments, operation 1101 may include an operation 1103 whose logic specifies that set of criteria includes an attribute of the gesture. The logic of operation 1103 may be performed, for example, by the gesture attributes determination module 239 provided by the criteria determination module 116 of the DGGS 110 described with reference to FIGS. 2A and 2G to determine context related information from the attributes of the gesture itself (e.g., color, size, direction, shape, and so forth).

In some embodiments, operation 1103 may further include an operation 1104 whose logic specifies that attribute of the gesture is a size of the gesture. The logic of operation 1104 may be performed, for example, by the gesture attributes determination module 239 provided by the criteria determination module 116 of the DGGS 110 described with reference to FIGS. 2A and 2G to determine context related information from the attributes of the gesture such as size. Size of the gesture may include, for example, width and/or length, and other measurements appropriate to the input device 20*.

In the same or different embodiments, operation 1103 may further include an operation 1105 whose logic specifies that attribute of the gesture is a direction of the gesture. The logic of operation 1103 may be performed, for example, by the gesture attributes determination module 239 provided by the criteria determination module 116 of the DGGS 110 described with reference to FIGS. 2A and 2G to determine context related information from the attributes of the gesture such as direction. Direction of the gesture may include, for example, up or down, east or west, and other measurements appropriate to the input device 20*.

In same or different embodiments, operation 1103 may further include an operation 1106 whose logic specifies that attribute of the gesture is a color. The logic of operation 1106 may be performed, for example, by the gesture attributes determination module 239 provided by the criteria determination 116 of the DGGS 110 described with reference to FIGS. 2A and 2G to determine context related information from the attributes of the gesture such as color. Color of the gesture may include, for example, a pen and/or ink color as well as other measurements appropriate to the input device 20*.

FIG. 11B is an example flow diagram of example logic illustrating various example embodiments of block 310 of FIG. 3. In some embodiments, the logic of operation 310 for upon receiving notification that the generated persistent representation has been retrieved, determining possible content to be presented, the determining based upon the indicated portion represented by the retrieved persistent representation and the auxiliary content associated with the retrieved persistent representation may further include operation 1101 whose logic specifies that determining possible content to be presented is based upon a set of criteria, which may further include operation 1103 whose logic specifies that set of criteria includes an attribute of the gesture. Operations 1101 and 1103 are described with reference to FIG. 11A. In some embodiments, the operation 1103 may further include an operation 1107 whose logic specifies that the attribute of the gesture is a measure of steering of the gesture. The logic of operation 1107 may be performed, for example, by the gesture attributes determination module 239 provided by the criteria determination module 116 of the DGGS 110 described with reference to FIGS. 2A and 2G to determine (e.g., retrieve, designate, resolve, etc.) context related information from the attributes of the gesture such as steering. Steering of the gesture may occur when, for example, an initial gesture is indicated (e.g., on a mobile device) and the user desires to correct or nudge it in a certain direction.

In some embodiments, operation 1107 may further include an operation 1108 whose logic specifies that steering of the gesture is accomplished by smudging the input device. The logic of operation 1108 may be performed, for example, by the gesture attributes determination module 239 provided by the criteria determination module 116 of the DGGS 110 described with reference to FIGS. 2A and 2G to determine context related information from the attributes of the gesture such as smudging. Smudging of the gesture may occur when, for example, an initial gesture is indicated (e.g., on a mobile device) and the user desires to correct or nudge it in a certain direction by, for example “smudging” the gesture using for example, a finger. This type of action may be particularly useful on a touch screen input device.

In the same or different embodiments, operation 1107 may further include an operation 1109 whose logic specifies that steering of the gesture is performed by a handheld gaming accessory. The logic of operation 1109 may be performed, for example, by the gesture attributes determination module 239 provided by the criteria determination module 116 of the DGGS 110 described with reference to FIGS. 2A and 2G to determine context related information from the attributes of the gesture such as steering. In this case the steering is performed by a handheld gaming accessory such as a particular type of input device 20*.

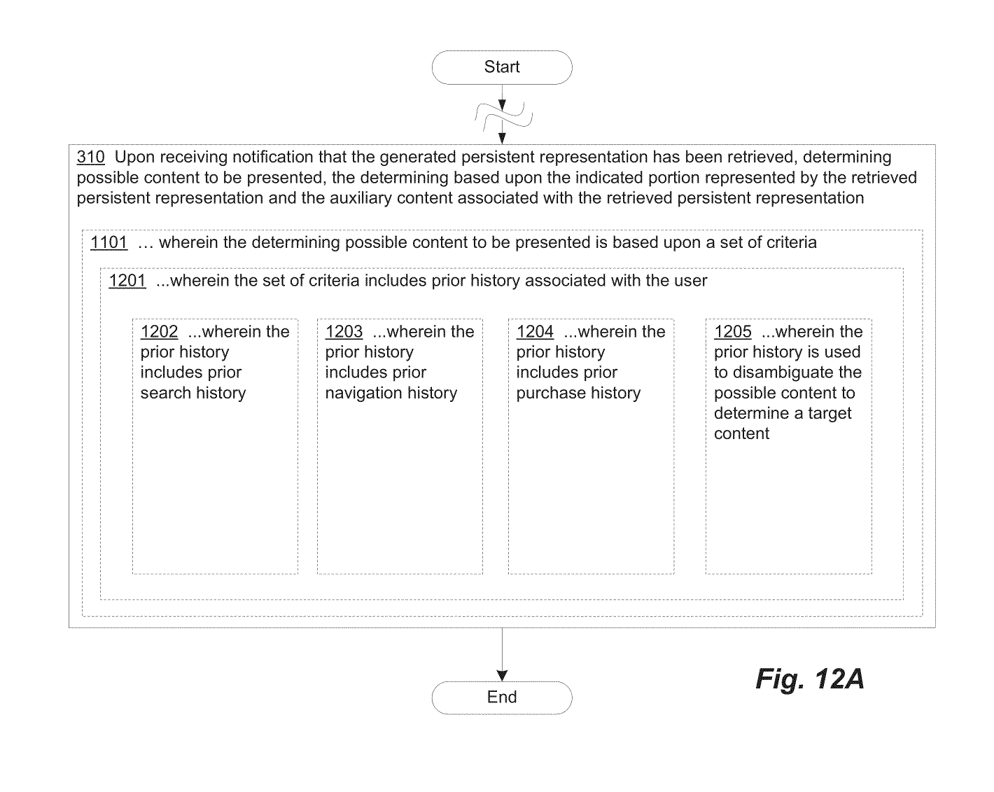

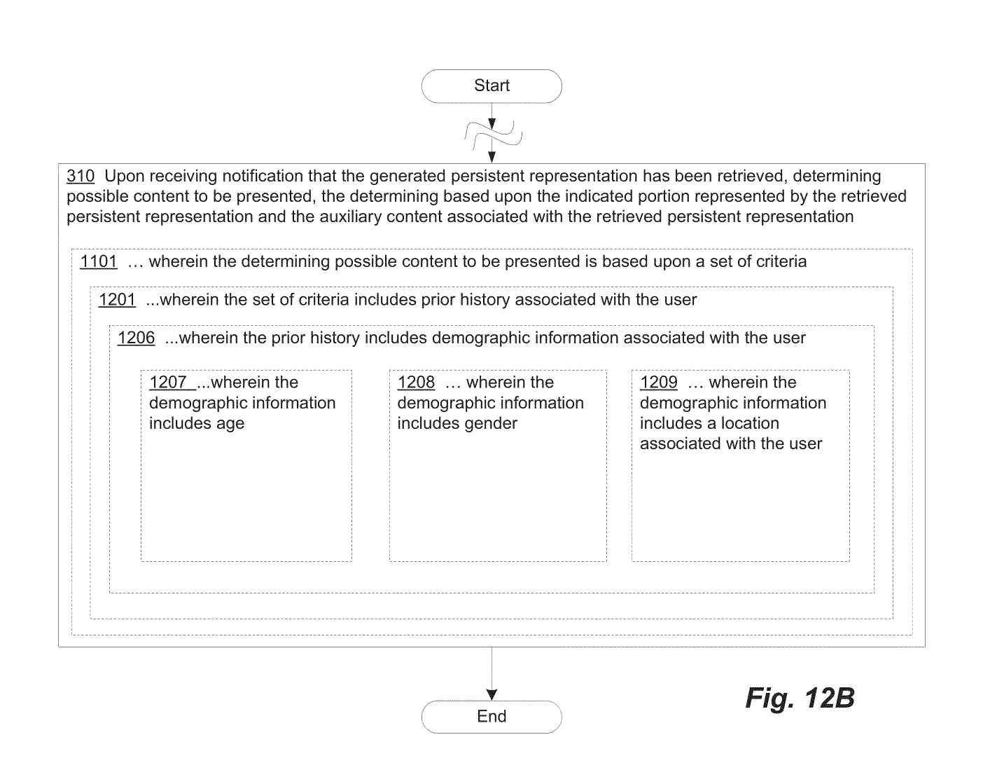

FIG. 12A is an example flow diagram of example logic illustrating various example embodiments of block 310 of FIG. 3. In some embodiments, the logic of operation 310 for upon receiving notification that the generated persistent representation has been retrieved, determining possible content to be presented, the determining based upon the indicated portion represented by the retrieved persistent representation and the auxiliary content associated with the retrieved persistent representation may further include operation 1101 whose logic specifies that determining possible content to be presented is based upon a set of criteria, which may further include operation 1201 whose logic specifies that set of criteria includes prior history associated with the user. The logic of operation by the prior history determination module 232 provided by the criteria determination module 230 provided by the content to present determination module 116 of the DGGS 110 described with reference to FIGS. 2A and 2G to determine a set of criteria (e.g., factors, aspects, and the like) based upon some kind of prior history associated with the user.

In the same or different embodiments, the logic of operation 1201 may include an operation 1202 whose logic specifies that prior history includes prior search history. The logic of operation 1202 may be performed, for example, by the search history determination module 235 provided by the prior history determination module 232 provided by the criteria determination module 116 of the DGGS 110 described with reference to FIGS. 2A and 2G to determine a set of criteria based upon the prior search history associated with the user. Factors such as what content the user has reviewed and searched for may be considered. Other factors may be considered as well.

In the same or different embodiments, the logic of operation 1201 may include an operation 1203 whose logic specifies that prior history includes prior navigation history. The logic of operation 1203 may be performed, for example, by the navigation history determination module 236 provided by the prior history determination module 232 provided by the criteria determination module 116 of the DGGS 110 described with reference to FIGS. 2A and 2G to determine a set of criteria based upon the prior navigation history associated with the user. Factors such as what content the user has reviewed, for how long, and where the user has navigated to from that point may be considered. Other factors may be considered as well.

In the same or different embodiments, the logic of operation 1201 may include an operation 1204 whose logic specifies that prior history includes prior purchase history. The logic of operation 1204 may be performed, for example, by the purchase history determination module 234 provided by the prior history determination module 232 provided by the criteria determination module 116 of the DGGS 110 described with reference to FIGS. 2A and 2G to determine a set of criteria based upon the prior purchase history associated with the user. Factors such as what products and/or services the user has bought may be considered. Other factors may be considered as well.

In the same or different embodiments, the logic of operation 1201 may further include an operation 1205 whose logic specifies that prior history includes demographic information associated with the user. The logic of operation 1205 may be performed, for example, by the prior history determination module 232 provided by the criteria determination module 116 of the DGGS 110 described with reference to FIGS. 2A and 2G. Prior history may provide insight to the DGGS 110, for example, to determine whether indicated content (hence indicated auxiliary content) points to certain persons, things, etc.

FIG. 12B is an example flow diagram of example logic illustrating various example embodiments of block 310 of FIG. 3. In some embodiments, the logic of operation 310 for upon receiving notification that the generated persistent representation has been retrieved, determining possible content to be presented, the determining based upon the indicated portion represented by the retrieved persistent representation and the auxiliary content associated with the retrieved persistent representation may further include operation 1101 whose logic specifies that determining possible content to be presented is based upon a set of criteria, which may further include operation 1201 whose logic specifies that set of criteria includes prior history associated with the user. Operations 1101 and 1201 are described with reference to FIG. 12A. In some embodiments, the operation 1201 may further include operation 1206 whose logic specifies that prior history includes demographic information associated with the user. The logic of operation 1206 may be performed, for example, by the demographic history determination module 233 provided by the prior history determination module 232 provided by the criteria determination module 116 of the DGGS 110 described with reference to FIGS. 2A and 2G to determine a set of criteria based upon the demographic history associated with the user. Factors such as what the age, gender, location, citizenship, religious preferences (if specified) may be considered. Other factors may be considered as well.

In some embodiments, the logic of operation 1206 may further include an operation 1207 whose logic specifies that the demographic information includes age. The logic of operation 1207 may be performed, for example, by the demographic history determination module 233 provided by the prior history determination module 232 provided by the criteria determination module 116 of the DGGS 110 described with reference to FIGS. 2A and 2G to determine a set of criteria based upon the demographic history associated with the user including age.

In the same or different embodiments, the logic of operation 1206 may further include an operation 1208 whose logic specifies that the demographic information includes gender. The logic of operation 1208 may be performed, for example, by the demographic history determination module 233 provided by the prior history determination module 232 provided by the criteria determination module 116 of the DGGS 110 described with reference to FIGS. 2A and 2G to determine a set of criteria based upon the demographic history associated with the user including gender.

In the same or different embodiments, the logic of operation 1206 may further include an operation 1209 whose logic specifies that the demographic information includes a location associated with the user. The logic of operation 1209 may be performed, for example, by the demographic history determination module 233 provided by the prior history determination module 232 provided by the criteria determination module 116 of the DGGS 110 described with reference to FIGS. 2A and 2G to determine a set of criteria based upon the demographic history associated with the user including location. Location may include any location associated with the user included a residence, a work location, a home town, a birth location, and so forth.

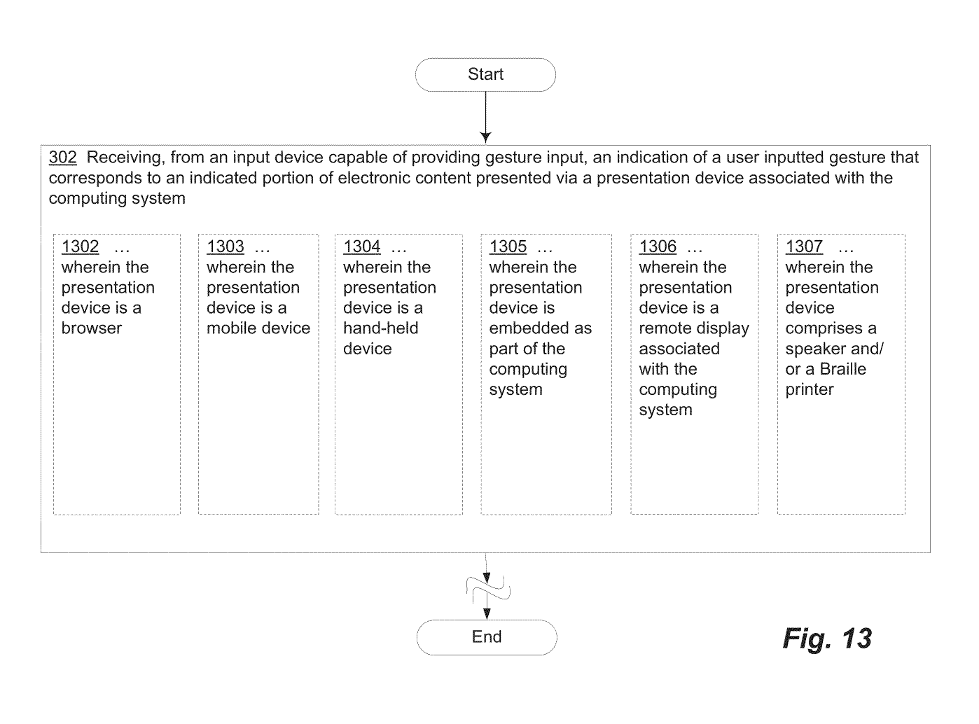

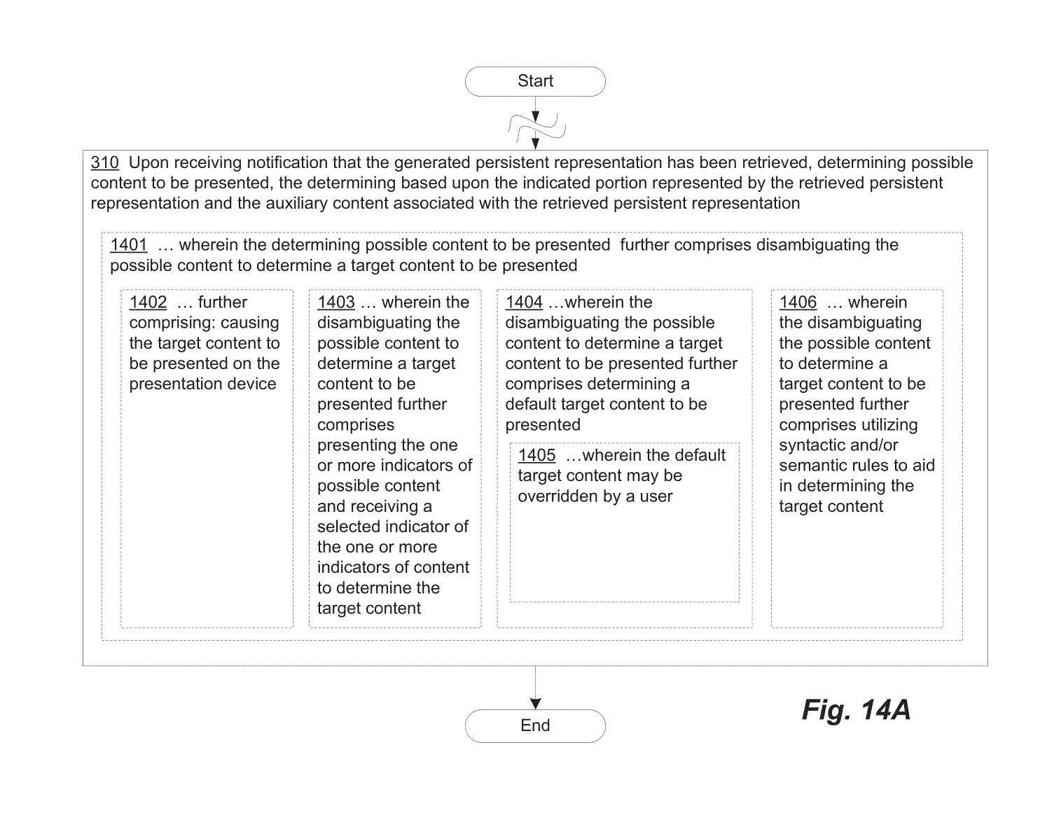

FIG. 13 is an example flow diagram of example logic illustrating various example embodiments of block 302 of FIG. 3. In the some embodiments, the logic of operation 302 for receiving, from an input device capable of providing gesture input, an indication of a user inputted gesture that corresponds to an indicated portion of electronic content presented via a presentation device associated with the computing system may include an operation 1302 whose logic specifies that the presentation device is a browser. The logic of operation 1302 may be performed, for example, by the specific device handlers module 258 provided by the presentation module 117 of the DGGS 110 described with reference to FIGS. 2A and 2I.

In the same or different embodiments, the logic of operation 302 may further include an operation 1303 whose logic specifies that the presentation device is a mobile device. The logic of operation 1303 may be performed, for example, by the specific device handlers module 258 provided by the presentation module 117 of the DGGS 110 described with reference to FIGS. 2A and 2I. Mobile devices may include any type of device, digital or analog, that can be made mobile, including, for example, a cellular phone, table, personal digital assistant, computer, laptop, radio, and the like.

In the same or different embodiments, the logic of operation 302 may further include an operation 1304 whose logic specifies that the presentation device is a hand-held device. The logic of operation 1304 may be performed, for example, by the specific device handlers module 258 provided by the presentation module 117 of the DGGS 110 described with reference to FIGS. 2A and 2I. Hand-held devices may include any type of device, digital or analog, that can be held, for example, a cellular phone, table, personal digital assistant, computer, laptop, radio, and the like.

In the same or different embodiments, the logic of operation 302 may further include an operation 1305 whose logic specifies that the presentation device is embedded as part of the computing system. The logic of operation 1305 may be performed, for example, by the specific device handlers module 258 provided by the presentation module 117 of the DGGS 110 described with reference to FIGS. 2A and 2I. Embedded devices include, for example, devices that have smart displays built into them, display screens specially constructed for the computing system, etc.

In the same or different embodiments, the logic of operation 302 may further include an operation 1306 whose logic specifies that the presentation device is a remote display associated with the computing system The logic of operation 1306 may be performed, for example, by the specific device handlers module 258 provided by the presentation module 117 of the DGGS 110 described with reference to FIGS. 2A and 2I. The remote display may be accessible, for example, over the networks 30, which are communicatively coupled to the DGGS 110.

In the same or different embodiments, the logic of operation 302 may further include an operation 1307 whose logic specifies that the presentation device comprises a speaker and/or a Braille printer. The logic of operation 1307 may be performed, for example, by the specific device handlers module 258 provided by the presentation module 117 of the DGGS 110 described with reference to FIGS. 2A and 2I, including the speaker device handler.

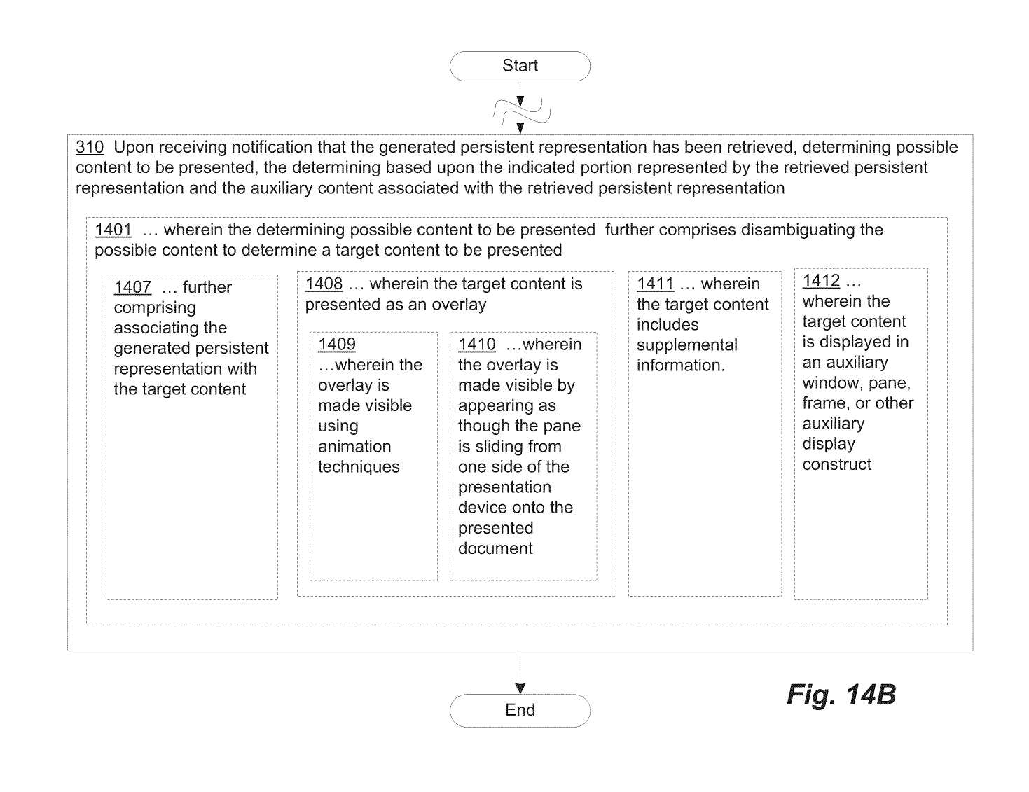

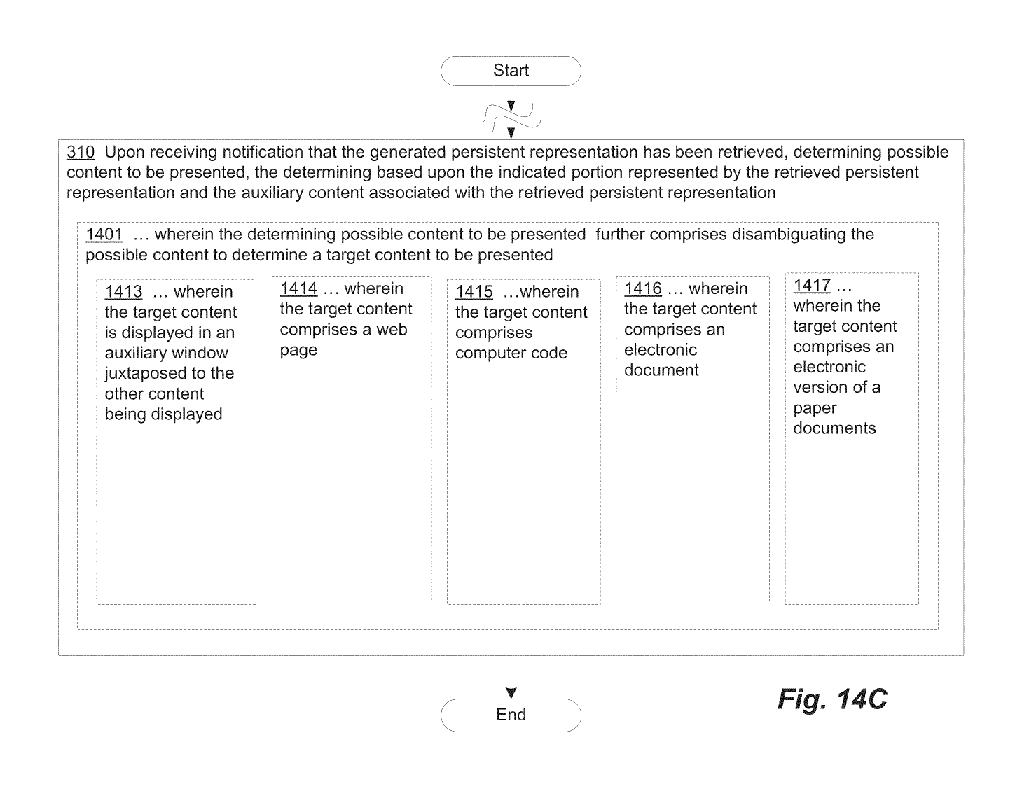

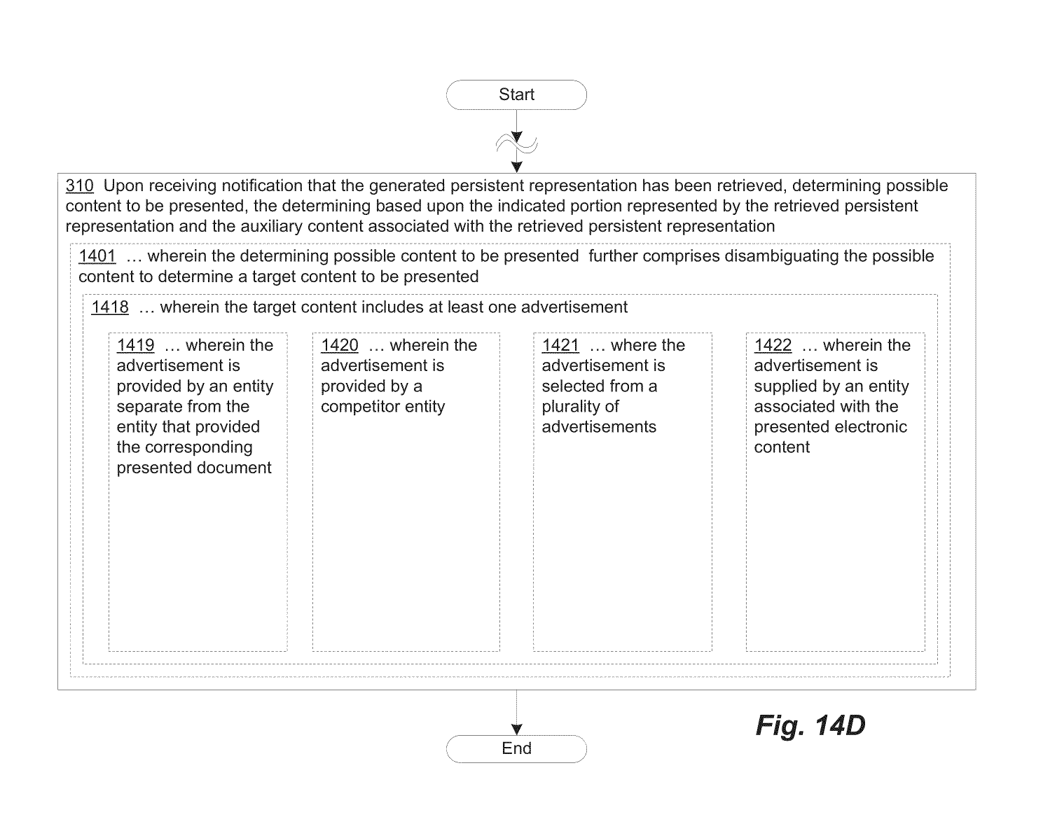

FIG. 14A is an example flow diagram of example logic illustrating various example embodiments of block 310 of FIG. 3. In some embodiments, the logic of operation 310 for upon receiving notification that the generated persistent representation has been retrieved, determining possible content to be presented, the determining based upon the indicated portion represented by the retrieved persistent representation and the auxiliary content associated with the retrieved persistent representation may further include operation 1402 whose logic specifies wherein determining possible content to be presented further comprises disambiguating the possible content to determine a target content to be presented. The logic of operation 1402 may be performed, for example, by the target content determination module 243 provided by the disambiguation module 240 provided by the content to present determination module 116 of the DGGS 110 described with reference to FIGS. 2A, 2G, and 2H. Disambiguating the possible content allows for the case where context may dictate one associated auxiliary content over another. For example, if the gesturelet is retrieved while a user is reading an article on a person “Bill” versus a Bill proposed to Congress, the target content may be selected (e.g., an advertisement) relating to something about Bill the person versus Bill the political document.

In the same or different embodiments, the logic of operation 310 may further include an operation 1403 whose logic specifies presenting the one or more indicators of possible content and receiving a selected indicator of the one or more indicators of content to determine the target content. The logic of operation 1403 may be performed, for example, by the target content determination module 243 provided by the disambiguation module 240 provided by the content to present determination module 116 of the DGGS 110 described with reference to FIGS. 2A, 2G, and 2H. Presenting the one or more indicators of possible auxiliary content allows a user 10* to select an auxiliary content to be presented, especially in the case where there is some sort of ambiguity.

In the same or different embodiments, the logic of operation 310 may further include an operation 1404 whose logic specifies determining a default target content to be presented. The logic of operation 1404 may be performed, for example, by the default target content determination module 245 provided by the disambiguation module 240 provided by the content to present determination module 116 of the DGGS 110 described with reference to FIGS. 2A and 2G.

In some embodiments, the logic of operation 1404 may further include an operation 1405 whose logic specifies that default target content may be overridden by a user. The logic of operation 1405 may be performed, for example, by the default target content determination module 245 provided by the disambiguation module 240 provided by the content to present determination module 116 of the DGGS 110 described with reference to FIGS. 2A and 2G. The DGGS 110 allows the user 10* to override an default auxiliary content presented in a variety of ways, including by specifying that no default content is to be presented.

In the same or different embodiments, the logic of operation 310 may further include an operation 1405 whose logic specifies utilizing syntactic and/or semantic rules to aid in determining the target content. The logic of operation 1405 may be performed, for example, by the syntactic/semantic rules and/or natural language processing module 241 provided by the disambiguation module 240 provided by the content to present determination module 116 of the DGGS 110 described with reference to FIGS. 2A and 2G. As described elsewhere, NLP-based mechanisms may be employed to determine what is meant by a gesture and hence what auxiliary content may be meaningful.

FIG. 14B is an example flow diagram of example logic illustrating various example embodiments of block 310 of FIG. 3. In some embodiments, the logic of operation 310 for upon receiving notification that the generated persistent representation has been retrieved, determining possible content to be presented, the determining based upon the indicated portion represented by the retrieved persistent representation and the auxiliary content associated with the retrieved persistent representation may further include operation 1401 whose logic specifies wherein determining possible content to be presented further comprises disambiguating the possible content to determine a target content to be presented as described with reference to FIG. 14A. In some embodiments, operation 1401 may further include operation 1407 whose logic specifies associating the generated persistent representation with the target content. The logic of operation 1407 may be performed, for example, by the target content determination module 243 provided by the disambiguation module 240 provided by the content to present determination module 116 of the DGGS 110 described with reference to FIGS. 2A, 2G, and 2H.

In the same or different embodiments, the logic of operation 1401 may include an operation 1408 whose logic specifies that target content is presented as an overlay. The logic of operation 1408 may be performed, for example, by the target content determination module 243 provided by the disambiguation module 240 provided by the content to present determination module 116 of the DGGS 110 described with reference to FIGS. 2A, 2G, and 2H using aspects of the presentation module 117 described with reference to FIG. 2I, including the overlay presentation module 252.

In some embodiments, the logic of operation 1408 may further include an operation 1409 whose logic specifies that overlay is made visible using animation techniques. The logic of operation 1409 may be performed, for example, by the disambiguation module 240 provided by the content to present determination module 116 of the DGGS 110 described with reference to FIGS. 2A and 2G using aspects of the presentation module 117 described with reference to FIG. 2I, including the overlay presentation module 252 and the animation module 254.

In the same or different embodiments, the logic of operation 1408 may further include an operation 1410 whose logic specifies that an overlay is made visible by appearing as though the pane is sliding from one side of the presentation device onto the presented document. The logic of operation 1410 may be performed, for example, by the disambiguation module 240 provided by the content to present determination module 116 of the DGGS 110 described with reference to FIGS. 2A and 2G using aspects of the presentation module 117 described with reference to FIG. 2I, including the overlay presentation module 252 and the animation module 254.

In the same or different embodiments, the logic of operation 1401 may include an operation 1411 whose logic specifies that target content includes supplemental information. The logic of operation 1411 may be performed, for example, by the supplemental content determination module 246 provided by the target content determination module 243 provided by the disambiguation module 240 provided by the content to present determination module 116 of the DGGS 110 described with reference to FIGS. 2A, 2G, 2H, and 2I.

In the same or different embodiments, the logic of operation 1401 may include an operation 1412 whose logic specifies that target content is displayed in an auxiliary window, pane, frame, or other auxiliary display construct. The logic of operation 1412 may be performed, for example, by the target content determination module 243 provided by the disambiguation module 240 provided by the content to present determination module 116 of the DGGS 110 described with reference to FIGS. 2A, 2G, and 2H using aspects of the presentation module 117 described with reference to FIG. 2I, including the auxiliary display generation module 256.

FIG. 14C is an example flow diagram of example logic illustrating various example embodiments of block 310 of FIG. 3. In some embodiments, the logic of operation 310 for upon receiving notification that the generated persistent representation has been retrieved, determining possible content to be presented, the determining based upon the indicated portion represented by the retrieved persistent representation and the auxiliary content associated with the retrieved persistent representation may further include operation 1401 whose logic specifies wherein determining possible content to be presented further comprises disambiguating the possible content to determine a target content to be presented as described with reference to FIG. 14A. In some embodiments, operation 1401 may further include operation 1413 whose logic specifies target content is displayed in an auxiliary window juxtaposed to the other content being displayed. The logic of operation 1413 may be performed, for example, by the target content determination module 243 provided by the disambiguation module 240 provided by the content to present determination module 116 of the DGGS 110 described with reference to FIGS. 2A, 2G, and 2H using aspects of the presentation module 117 described with reference to FIG. 2I, including the auxiliary display generation module 256.

In the same or different embodiments, the logic of 1401 may further include an operation 1414 whose logic specifies that the target content comprises a web page. The logic of operation 141 may be performed, for example, by the target content determination module 243 provided by the target content determination module 243 provided by the disambiguation module 240 provided by the content to present determination module 116 of the DGGS 110 described with reference to FIGS. 2A, 2G, and 2H, using aspects of the presentation module 117 described with reference to FIG. 2I, including the specific device handlers module 258 which includes a browser hander.

In the same or different embodiments, the logic of operation 1401 may further include an operation 1415 whose logic specifies that the target content comprises computer code. The logic of operation 1415 may be performed, for example, by the target content determination module 243 provided by the disambiguation module 240 provided by the content to present determination module 116 of the DGGS 110 described with reference to FIGS. 2A, 2G, and 2H, using aspects of the presentation module 117 described with reference to FIG. 2I.

In the same or different embodiments, the logic of operation 1401 may further include an operation 1416 whose logic specifies that the target content comprises an electronic document. The logic of operation 1416 may be performed, for example, by the target content determination module 243 provided by the disambiguation module 240 provided by the content to present determination module 116 of the DGGS 110 described with reference to FIGS. 2A, 2G, and 2H, using aspects of the presentation module 117 described with reference to FIG. 2I.

In the same or different embodiments, the logic of operation 1410 may further include an operation 1417 whose logic specifies that the target content comprises an electronic version of a paper documents. The logic of operation 1417 may be performed, for example, by the target content determination module 243 provided by the disambiguation module 240 provided by the content to present determination module 116 of the DGGS 110 described with reference to FIGS. 2A, 2G, and 2H, using aspects of the presentation module 117 described with reference to FIG. 2I.

FIG. 14D is an example flow diagram of example logic illustrating various example embodiments of block 310 of FIG. 3. In some embodiments, the logic of operation 310 for upon receiving notification that the generated persistent representation has been retrieved, determining possible content to be presented, the determining based upon the indicated portion represented by the retrieved persistent representation and the auxiliary content associated with the retrieved persistent representation may further include operation 1401 whose logic specifies wherein determining possible content to be presented further comprises disambiguating the possible content to determine a target content to be presented as described with reference to FIG. 14A. In some embodiments, operation 1401 may further include operation 1418 whose logic specifies target content includes at least one advertisement. The logic of operation 1418 may be performed, for example, by the advertisement determination module 247 provided by the target content determination module 243 provided by the disambiguation module 240 provided by the content to present determination module 116 of the DGGS 110 described with reference to FIGS. 2A, 2G, 2H, and 2I.

In some embodiments, the logic of operation 1418 may further include an operation 1419 whose logic specifies that the advertisement is provided by an entity separate from the entity that provided the corresponding presented document. The logic of operation 1419 may be performed, for example, by the advertisement determination module 247 provided by the target content determination module 243 provided by the disambiguation module 240 provided by the content to present determination module 116 of the DGGS 110 described with reference to FIGS. 2A, 2G, 2H, and 2I.

In the same or different embodiments the logic of operation 1418 may further include an operation 1420 whose logic specifies that the advertisement is provided by a competitor entity. The logic of operation 1420 may be performed, for example, by the advertisement determination module 247 provided by the target content determination module 243 provided by the disambiguation module 240 provided by the content to present determination module 116 of the DGGS 110 described with reference to FIGS. 2A, 2G, 2H, and 2I.

In the same or different embodiments the logic of operation 1418 may further include an operation 1421 whose logic specifies that the advertisement is selected from a plurality of advertisements. The logic of operation 1421 may be performed, for example, by the advertisement determination module 247 provided by the target content determination module 243 provided by the disambiguation module 240 provided by the content to present determination module 116 of the DGGS 110 described with reference to FIGS. 2A, 2G, 2H, and 2I.

In the same or different embodiments the logic of operation 1418 may further include an operation 1422 whose logic specifies that the advertisement is supplied by an entity associated with the presented electronic content. The logic of operation 1422 may be performed, for example, by the advertisement determination module 247 provided by the target content determination module 243 provided by the disambiguation module 240 provided by the content to present determination module 116 of the DGGS 110 described with reference to FIGS. 2A, 2G, 2H, and 2I.

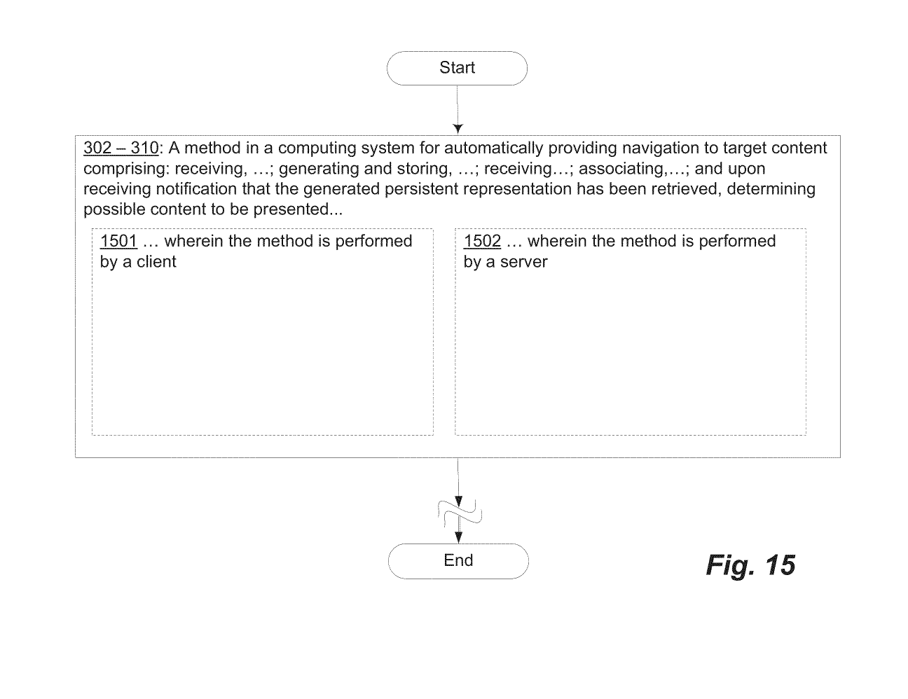

FIG. 15 is an example flow diagram of example logic illustrating various example embodiments of operations 302 to 310 of FIG. 3. In particular, the logic of the operations 302 to 310 may further include logic 1501 that specifies that the entire method is performed by a client. As described earlier, a client may be hardware, software, or firmware, physical or virtual, and may be part or the whole of a computing system. A client may be an application or a device.

In the same or different embodiments, the logic of the operations 302 to 310 may further include logic 1502 that specifics that the entire method is performed by a server. As described earlier, a server may be hardware, software, or firmware, physical or virtual, and may be part or the whole of a computing system. A server may be service as well as a system.

FIG. 16 is an example block diagram of a computing system for practicing embodiments of a Dynamic Gesturelet Generation System as described herein. Note that a general purpose or a special purpose computing system suitably instructed may be used to implement an DGGS, such as DGGS 110 of FIG. 1.

Further, the DGGS may be implemented in software, hardware, firmware, or in some combination to achieve the capabilities described herein.

The computing system 100 may comprise one or more server and/or client computing systems and may span distributed locations. In addition, each block shown may represent one or more such blocks as appropriate to a specific embodiment or may be combined with other blocks. Moreover, the various blocks of the DGGS 110 may physically reside on one or more machines, which use standard (e.g., TCP/IP) or proprietary interprocess communication mechanisms to communicate with each other.

In the embodiment shown, computer system 100 comprises a computer memory (“memory”) 101, a display 1602, one or more Central Processing Units (“CPU”) 1603, Input/Output devices 1604 (e.g., keyboard, mouse, CRT or LCD display, etc.), other computer-readable media 1605, and one or more network connections 1606. The DGGS 110 is shown residing in memory 101. In other embodiments, some portion of the contents, some of, or all of the components of the DGGS 110 may be stored on and/or transmitted over the other computer-readable media 1605. The components of the DGGS 110 preferably execute on one or more CPUs 1603 and manage providing automatic navigation to auxiliary content, as described herein. Other code or programs 1630 and potentially other data repositories, such as data repository 1620, also reside in the memory 101, and preferably execute on one or more CPUs 1603. Of note, one or more of the components in FIG. 16 may not be present in any specific implementation. For example, some embodiments embedded in other software may not provide means for user input or display.

In a typical embodiment, the DGGS 110 includes one or more input modules 111, one or more persistent gesturelet representation generation modules 112, one or more auxiliary determination modules 113, one or more gesturelet association modules 114, one or more persistent representation retrieval detection modules 115, one or more content to present determination modules 116, and one or more presentation modules 117. In at least some embodiments, the persistent representation data 41 is provided external to the DGGS 110 and is available, potentially, over one or more networks 30. Other and/or different modules may be implemented. In addition, the DGGS 110 may interact via a network 30 with application or client code 1655 that can absorb gesturelets, for example, for other purposes, one or more client computing systems or client devices 20*, and/or one or more third-party content provider systems 1665, such as third party advertising systems or other purveyors of auxiliary content. Also, of note, the history data repository 1615 may be provided external to the DGGS 110 as well, for example in a knowledge base accessible over one or more networks 30.

In an example embodiment, components/modules of the DGGS 110 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an DGGS implementation.

In addition, programming interfaces to the data stored as part of the DGGS 110 (e.g., in the data repositories 1615 and 41) can be available by standard means such as through C, C++, C#, and Java APIs; libraries for accessing files, databases, or other data repositories; through scripting languages such as XML; or through Web servers, FTP servers, or other types of servers providing access to stored data. The repositories 1615 and 41 may be implemented as one or more database systems, file systems, or any other method known in the art for storing such information, or any combination of the above, including implementation using distributed computing techniques.

Also the example DGGS 110 may be implemented in a distributed environment comprising multiple, even heterogeneous, computer systems and networks. For example, in one embodiment, the components 111-117 are all located in physically different computer systems. In another embodiment, various modules of the DGGS 110 are hosted each on a separate server machine and may be remotely located from the tables which are stored in the data repositories 1615 and 41. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an DGGS.

Furthermore, in some embodiments, some or all of the components of the DGGS 110 may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored (e.g., as executable or other machine readable software instructions or structured data) on a computer-readable medium (e.g., a hard disk; a memory; a network; or a portable media article to be read by an appropriate drive or via an appropriate connection). Some or all of the components and/or data structures may be stored on tangible storage mediums. Some or all of the system components and data structures may also be transmitted in a non-transitory manner via generated data signals (e.g., as part of a carrier wave or other analog or digital propagated signal) on a variety of computer-readable transmission mediums, such as media 1605, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

From the foregoing it will be appreciated that, although specific embodiments have been described herein for purposes of illustration, various modifications may be made without deviating from the spirit and scope of the claims. For example, the methods and systems for performing automatic navigation to auxiliary content discussed herein are applicable to other architectures other than a windowed or client-server architecture. Also, the methods and systems discussed herein are applicable to differing protocols, communication media (optical, wireless, cable, etc.) and devices (such as wireless handsets, electronic organizers, personal digital assistants, tablets, portable email machines, game machines, pagers, navigation devices such as GPS receivers, etc.).

1. A method in a computing system for automatically providing auxiliary content, comprising:
receiving, from an input device capable of providing gesture input, an indication of a user inputted gesture that corresponds to an indicated portion of electronic content presented via a presentation device associated with the computing system;
generating and storing a persistent representation of the indicated portion, wherein the persistent representation is accessible separately from the electronic content;
receiving one or more indicators of auxiliary content;
associating the generated persistent representation with the one or more indicators of auxiliary content; and
upon receiving notification that the generated persistent representation has been retrieved, determining possible content to be presented, the determining based upon the indicated portion represented by the retrieved persistent representation and the auxiliary content associated with the retrieved persistent representation.

2. The method of claim 1 wherein the generated persistent representation is a uniform resource identifier.

3. The method of claim 1 wherein the generated persistent representation is stored as a uniform resource identifier.

4. The method of claim 1 wherein the generated persistent representation is stored in at least one of a file, a memory, and/or a data repository.

5. The method of claim 1 wherein the generated persistent representation is stored as a network resource.

6. The method of claim 1 wherein the associating the generated persistent representation with the one or more indicators of auxiliary content further comprises:
associating the generated persistent representation with an advertisement.

7. The method of claim 6 wherein the advertisement is supplied by an entity other than an entity associated with the presented electronic content, is supplied by an entity that competes against an entity associated with the presented electronic content, is selected from a plurality of advertisements, and/or is supplied by an entity associated with the presented electronic content.

8.-10. (canceled)

11. The method of claim 1 wherein the associating the generated persistent representation with the one or more indicators of auxiliary content further comprises:
associating the generated persistent representation with an opportunity for commercialization.

12. The method of claim 11 wherein the opportunity for commercialization is at least one of an advertisement, interactive entertainment, a role-playing game, a computer-assisted competition, and/or effectuated by bidding.

13.-16. (canceled)

17. The method of claim 1 wherein the associating the generated persistent representation with the one or more indicators of auxiliary content further comprises:
associating the generated persistent representation with information supplemental to the presented electronic content.

18. The method of claim 1 wherein the associating the generated persistent representation with the one or more indicators of auxiliary content further comprises:
associating the generated persistent representation with a purchase and/or an offer.

19. The method of claim 18 wherein the purchase and/or an offer is for at least one of information, an item for sale, a service for offer, a service for sale, a prior purchase of the user, a current purchase, and/or a purchase of someone that is part of a social network of the user.

20.-24. (canceled)

25. The method of claim 1 wherein the input device is at least one of a mouse, a touch sensitive display, a wireless device, a human body part, a microphone, a stylus, and/or a pointer.

26. The method of claim 1 wherein the user inputted gesture approximates a circle shape.

27. The method of claim 1 wherein the user inputted gesture approximates at least one of an oval shape, a closed path, and/or a polygon.

28. The method of claim 1 wherein the user inputted gesture is an audio gesture.

29. The method of claim 28 wherein the audio gesture is at least one of a spoken word or phrase and/or a direction.

30. (canceled)

31. The method of claim 1 wherein the indicated portion of the presented electronic content includes at least a word or a phrase.

32. The method of claim 1 wherein the indicated portion of the presented electronic content includes at least a graphical object, image, and/or icon.

33. The method of claim 1 wherein the indicated portion of the presented electronic content includes an utterance.

34. The method of claim 1 wherein the indicated portion of the presented electronic content comprises non-contiguous parts or contiguous parts.

35. (canceled)

36. The method of claim 1 wherein receiving one or more indicators of auxiliary content further comprises:
receiving one or more indicators of auxiliary content that is based upon the indicated portion.

37. The method of claim 1 wherein the determining possible content to be presented is based upon a set of criteria.

38. The method of claim 37 wherein the set of criteria includes context of other text, graphics, and/or objects within the presented electronic content.

39. The method of claim 37 wherein the set of criteria includes an attribute of the gesture.

40. The method of claim 39 wherein the attribute of the gesture is at least one of a size of the gesture, a direction of the gesture, a color, and/or a measure of steering of the gesture.

41.-45. (canceled)

46. The method of claim 37 wherein the set of criteria includes prior history associated with the user.

47. The method of claim 46 wherein the prior history includes at least one of prior search history, prior navigation history, prior purchase history, and/or demographic information associated with the user prior search history.

48.-53. (canceled)

54. The method of claim 46 wherein the prior history is used to disambiguate the possible content to determine a target content.

55. The method of claim 1 wherein the presentation device is at least one of a browser, a mobile device, a hand-held device, embedded as part of the computing system, a remote display associated with the computing system, a speaker, or a Braille printer.

56.-60. (canceled)

61. The method of claim 1 wherein the determining possible content to be presented further comprises:
disambiguating the possible content to determine a target content to be presented.

62. The method of claim 61, further comprising:
causing the target content to be presented on the presentation device.

63. The method of claim 61 wherein the disambiguating the possible content to determine a target content to be presented further comprises:
presenting the one or more indicators of possible content and receiving a selected indicator of the one or more indicators of content to determine the target content.

64. The method of claim 61 wherein the disambiguating the possible content to determine a target content to be presented further comprises:
determining a default target content to be presented.

65. The method of claim 64 wherein the default target content may be overridden by a user.

66. The method of claim 61 wherein the disambiguating the possible content to determine a target content to be presented further comprises:
utilizing syntactic and/or semantic rules to aid in determining the target content.

67. The method of claim 61, further comprising:
associating the generated persistent representation with the target content.

68. The method of claim 61 wherein the target content is presented as an overlay.

69. (canceled)

70. The method of claim 68 wherein the overlay is made visible by appearing as though the pane is sliding from one side of the presentation device onto the presented document.

71. The method of claim 61 wherein the target content includes at least one advertisement.

72. The method of claim 71 wherein the advertisement is provided by at least one of an entity separate from the entity that provided the presented electronic content, a competitor entity, and/or an entity associated with the presented electronic content.

73. (canceled)

74. The method of claim 71 where the advertisement is selected from a plurality of advertisements.

75. (canceled)

76. The method of claim 61 wherein the target content includes supplemental information.

77. The method of claim 61 wherein the target content is displayed in an auxiliary window, pane, frame, or other auxiliary display construct.

78. The method of claim 61 wherein the target content is displayed in an auxiliary window juxtaposed to the other content being displayed.

79. The method of claim 61 wherein the target content comprises at least one of computer code, a web page, an electronic document, an electronic version of a paper document.

80.-82. (canceled)

83. The method of claim 1 performed by a client or by a server.

84.-242. (canceled)
